(19) United States
(12) Patent Application Publication
(10) Pub. No.: US 2013/0195008 A1
(43) Pub. Date: Aug. 1, 2013

(54) Providing Feedback For Multiple Downlink Multiple-Input-Multiple-Output (MIMO) Streams

(71) Applicants: Benoit Pelletier, Roxboro (CA); Hong O. Zhang, Manalapan, NJ (US); Luijing Cai, Morganville, NJ (US)

(72) Inventors: Benoit Pelletier, Roxboro (CA); Hong O. Zhang, Manalapan, NJ (US); Luijing Cai, Morganville, NJ (US)

(73) Assignee: INTERDIGITAL PATENT HOLDINGS, INC., Wilmington, DE (US)

(21) Appl. No.: 13/571,493

(22) Filed: Aug. 10, 2012

Related U.S. Application Data
(60) Provisional application No. 61/523,241, filed on Aug. 12, 2011.
(60) Provisional application No. 61/555,845, filed on Nov. 4, 2011.
(60) Provisional application No. 61/591,694, filed on Jan. 27, 2012.
(60) Provisional application No. 61/612,207, filed on Mar. 16, 2012.

(51) Int. Cl. H04W 24/10

(52) U.S. Cl. CPC H04W 24/10
USPC 370/328

(57) ABSTRACT

A wireless-transmit-and-receiving unit (WTRU) supports receiving information via a plurality of multiple-input-multiple-output (MIMO) streams by providing a low-rank feedback report to a base station. The WTRU selects a preferred HS-PDSCH transmission rank, from a subset of ranks that the WTRU supports. The subset includes ranks that are lower than the maximum HS-PDSCH transmission rank supported by the WTRU. For example, for a WTRU that supports rank-4 reception, the subset may include rank-1 and rank-2. The WTRU generates the low-rank feedback report based on the preferred rank, and transmits the report to the base station.

### CROSS REFERENCE TO RELATED APPLICATIONS

This application claims the benefit of U.S. Provisional Application Ser. No. 61/523,241 filed Aug. 12, 2011, U.S. Provisional Application Ser. No. 61/555,845, filed Nov. 4, 2011, U.S. Provisional Application Ser. No. 61/591,694 filed Jan. 27, 2012, and U.S. Provisional Application Ser. No. 61/612,207 filed Mar. 16, 2012, all of which are hereby incorporated by reference herein.

### BACKGROUND

In the third generation partnership project (3GPP) wireless communication systems, the downlink data channel may carry different amounts of data using different spreading codes and different modulation and coding schemes (MCSs). The amount of data that can be delivered to a user equipment (UE) over the HS-DSCH depends in part on the downlink channel quality. The UE provides feedback information associated with the downlink channel quality to a base station such as a Node-B.

Feedback information may include positive acknowledgement/negative acknowledgement (ACK/NACK) information for hybrid automatic repeat request (HARQ), channel quality indication (CQI) information, precoding matrix information (PMI) and/or rank indication (RI). Feedback information may be transmitted to the network over the high speed dedicated physical control channel (HS-DPCCH) feedback channel in the uplink. However, current technologies may not efficiently provide feedback information for more than two streams on the downlink, for example, to support 4-branch multiple-input-multiple output (MIMO).

### SUMMARY

Systems, methods and instrumentalities that may provide for sending feedback for multiple downlink multiple-input-multiple output (MIMO) streams. Feedback information may be sent via high speed dedicated physical control channel (HS-DPCCH). Feedback information may include hybrid automatic repeat request (HARQ) positive acknowledgement/negative acknowledgement (ACK/NACK), channel quality indication (CQI), precoding control indication (PCI) and or rank indicator (RI).

In an embodiment, a wireless-transmit-and-receiving unit (WTRU) may provide a low-rank feedback report to a base station. A preferred HS-PDSCH transmission rank may be selected from a subset of HS-PDSCH transmission ranks that the WTRU supports. The subset may include ranks that may be lower than the maximum HS-PDSCH transmission rank supported by the WTRU. For example, for a WTRU that supports rank-4 reception, the subset may include rank-1 and rank-2. The WTRU may generate the low-rank feedback report based on the preferred rank. For example, the low-rank feedback report may include a rank indicator indicating the preferred HS-PDSCH transmission rank, precoding control information (PCI) associated with the preferred HS-PDSCH transmission rank, and/or channel quality information (CQI) associated with the preferred HS-PDSCH transmission rank.

In an embodiment, the WTRU may transmit low-rank feedback reports, type A feedback reports and rank-1 feedback reports interspersedly. The rank-1 feedback report may include feedback information associated with a stream with the best channel quality. For example, the type A feedback report may include feedback information associated with the maximum High Speed-Physical Downlink Shared Channel (HS-PDSCH) transmission rank supported by the WTRU. The type A feedback report may include a CQI associated with a first codeword and a CQI associated with a second codeword, and the CQIs may be transmitted in separate High Speed Dedicated Physical Control Channel (HS-DPCCH) subframes.

The WTRU may be configured with multiple CQI tables and may select a CQI table for providing feedback information based on the preferred HS-PDSCH transmission rank. The CQI and the preferred rank may be transmitted to the base station in a feedback report. The base station may be configured with the same CQI tables and may select a CQI table based on the preferred rank indicated in the feedback report for interpreting the feedback report. The base station may determine channel quality using the selected CQI table.

This Summary is provided to introduce a selection of concepts in a simplified form that are further described below in the Detailed Description of Illustrative Embodiments. This Summary is not intended to identify key features or essential features of the claimed subject matter, nor is it intended to be used to limit the scope of the claimed subject matter.

### BRIEF DESCRIPTION OF THE DRAWINGS

A more detailed understanding may be had from the following description, given by way of example in conjunction with the accompanying drawings wherein.

FIG. 1A is a system diagram of an example communications system in which one or more disclosed embodiments may be implemented.

FIG. 1B is a system diagram of an example wireless transmit/receive unit (WTRU) that may be used within the communications system illustrated in FIG. 1A.

FIG. 1C is a system diagram of an example radio access network and an example core network that may be used within the communications system illustrated in FIG. 1A.

FIG. 1D is a block diagram illustrating an example multi-antenna base station and multi-antenna WTRU for providing feedback for multiple downlink multiple-input-multiple-output (MIMO) streams.

FIG. 2 is a block diagram illustrating an example High-Speed Dedicated Physical Control Channel (HS-DPCCH) subframes for reporting channel information associated with multiple downlink MIMO streams.

FIG. 3 is a diagram illustrating an example of encoding channel information to facilitate reporting channel information using a HS-DPCCH.

FIG. 4 illustrates an example flow for encoding channel information to facilitate reporting channel information using a HS-DPCCH.

FIG. 5 illustrates a table providing a mapping for recovering RI from a combination of a representation of RI and an indication of a number of layers.

FIG. 6 illustrates a table providing a mapping for recovering RI from a combination of a representation of RI and an indication of a number of layers.

FIG. 7 illustrates an example extended CQI table.

FIG. 8 illustrates Code rate vs. transport block size (TBS) for the example extended CQI table;

FIG. 9 illustrates an example extended CQI table without overlapping.

FIG. 10 is code rate vs. TBS relationship with no TBS overlap.

FIG. 11 depicts transmission of joint RI/PMI/CQI across adjacent HS-DPCCH subframes.

FIGS. 12 and 13 depict joint coding and transmission over two HS-DPCCH subframes.

FIG. 14 depicts joint coding using convolutional encoding.

FIG. 15 is an example TDM approach with partially joint coding of feedback parameters.

FIG. 16 shows composite RI/CQI information multiplexing and coding.

FIG. 17 shows PMI/CQI2 multiplexing and coding.

FIG. 18 shows TDM based RI/PMI/CQI2 multiplexing and coding with equal coding rate.

FIG. 19 shows an example having a low-rank composite PMI/CQI information report.

FIG. 20 shows an example having low-rank composite RI/PMI/CQI information report.

FIG. 21 shows an example having low-rank composite RI/PMI/CQI information report for two layers.

FIG. 22 shows TDM based multiplexing for two carriers.

FIG. 23 shows dual channelization code based multiplexing for two carriers.

FIG. 24 shows multiplexing based on reduced spreading factor for two carriers.

FIG. 25 shows TDM based CQI multiplexing using the equal code rate approach for two carriers.

FIG. 26 shows multiplexing and coding with a CQI coding scheme for DC-HSDPA.

FIG. 27 depicts an embodiment of channel coding of HARQ-ACK.

FIG. 28 depicts an alternative embodiment of channel coding of HARQ-ACK.

FIG. 29 is an example of PMI to codeword layer mapping.

FIG. 30A-C illustrate example low-rank/high rank reporting.

FIG. 31 is an example reporting when CQI cycle is 6 with 3 composite rank-1 extended type B reports.

FIG. 32 illustrates example process for reporting feedback using multiple CQI tables.

FIG. 33 illustrates an example process for transmitting a low-rank feedback report.

FIG. 34 illustrates another example of multiplexing and coding for feedback information using a TDM approach with partially joint coding.

### DETAILED DESCRIPTION OF ILLUSTRATIVE EMBODIMENTS

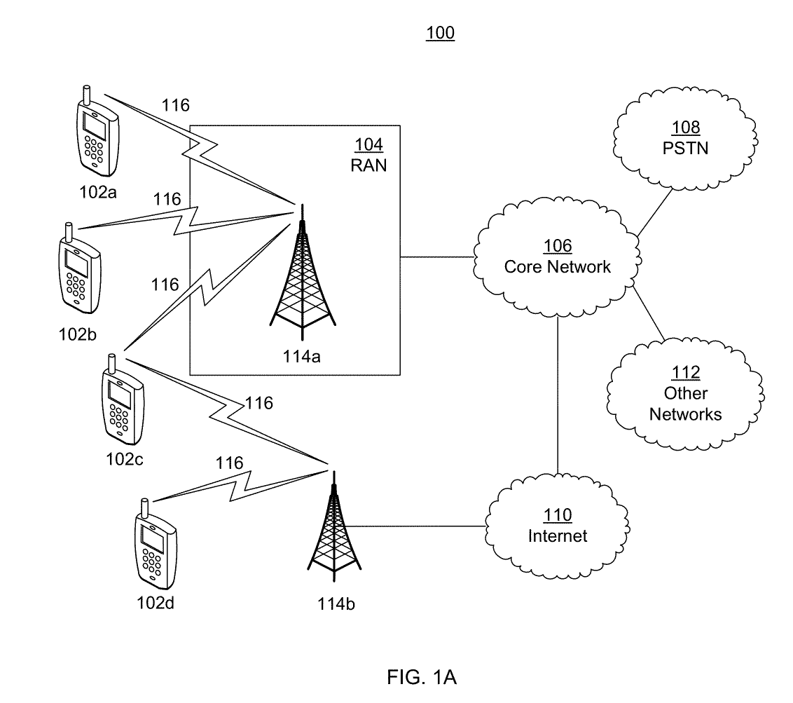

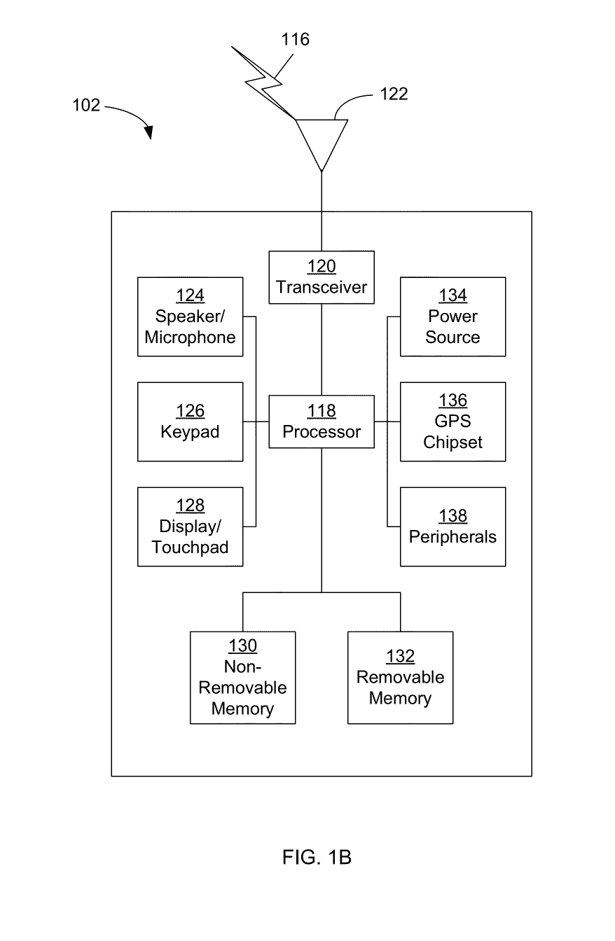

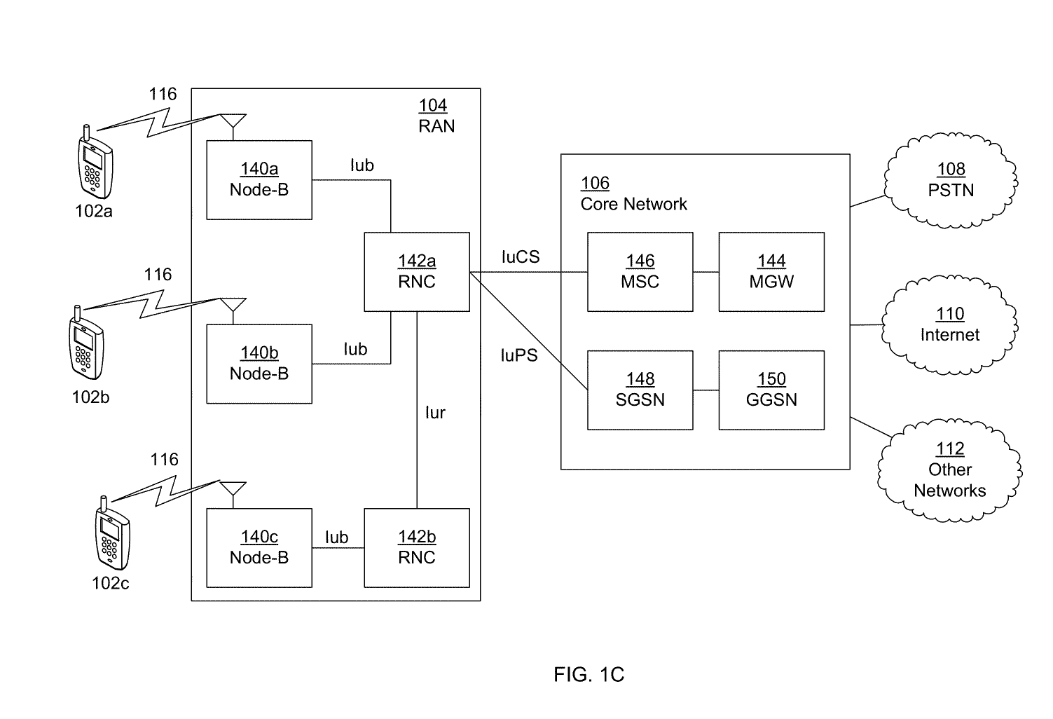

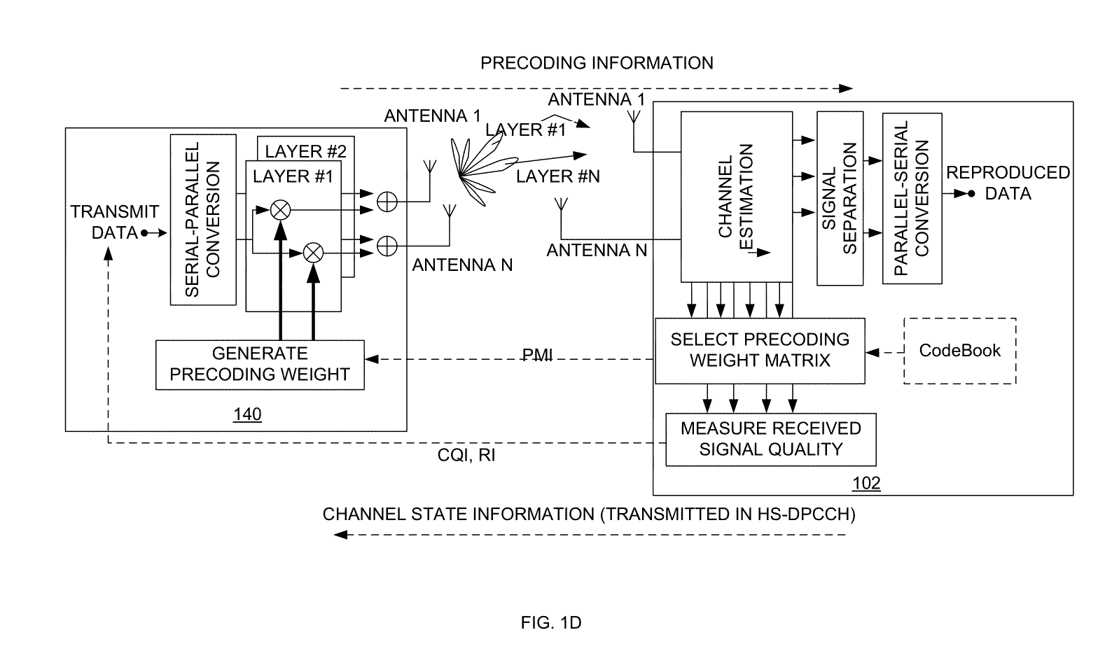

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers and/or antennas for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1x, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ a UTRA radio technology to communicate with the WTRUs 102a, 102b, 102c over the air interface 116. The RAN 104 may also be in communication with the core network 106. As shown in FIG. 1C, the RAN 104 may include Node-Bs 140a, 140b, 140c, which may each include one or more transceivers for communicating with the WTRUs 102a, 102b, 102c over the air interface 116. The Node-Bs 140a, 140b, 140c may each be associated with a particular cell (not shown) within the RAN 104. The RAN 104 may also include RNCs 142a, 142b. It will be appreciated that the RAN 104 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 104 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 104 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a block diagram illustrating an example multi-antenna base station and multi-antenna WTRU adapted for providing feedback for multiple downlink multiple-input-multiple-output (MIMO) streams. As shown, a Node-B 140 may use multiple antennas to transmit wireless signals to, and receive wireless signals from, a WTRU 102a. The transmission and reception may include multiple layers, such as layer #1 . . . layer #n.

When carrying out the 2×2-MIMO operations, the WTRU may experience a peak data rate on the downlink that may vary based on radio conditions. Under certain radio conditions, an achievable rate for the 2×2-MIMO-peak-data rate may be roughly twenty eight (28) megabits-per-second (Mbps). As compared to single-antenna and/or single-input-single-output (SISO) operations, the 2×2-MIMO-peak-data rate may be roughly twice that of a peak data rate for SISO operations. In addition to a two-fold increase in peak data rate, carrying out the 2×2-MIMO operations may improve spectral efficiency over SISO operations. 4-branch MIMO, or 4 downlink MIMO streams for HSDPA may further increase cell-edge data rates, peak data rates, as well as system capacity.

To support 4 or more layers or downlink MIMO streams on the downlink of HSDPA, the WTRU may send channel state information (CSI) to a Node-B. For example, for each transport block (TB), the WTRU may send the associated precoding control information (PCI), channel quality information (CQI), rank information (RI), and/or other channel information. The WTRU may generate a composite report of the PCI and CQI for reporting the PCI, CQI and RI for transmission to the Node-B (composite PCI/CQI report). The WTRU may periodically transmit the composite PCI/CQI report to the Node-B on a high-speed dedicated physical control channel (HS-DPCCH). The RI may be explicitly sent or may be embedded into the CQI. While certain embodiment(s) may be described in the context of explicit RIs, it is understood that such embodiment(s) may apply to embedded or implicit RIs. While certain embodiment(s) may be described in the context of embedded or implicit RIs, it is understood that such embodiment(s) may apply to explicit RIs.

In an embodiment, an HS-DPCCH subframe may include 3 slots. The composite PCI/CQI report may be carried in the last two slots of a HS-DPCCH subframe. The HS-DPCCH may be carried on a channel that may be spread using a spreading factor (SF) equal to 256, leaving thus 20 coded bits per HS-DPCCH subframe.

The composite PCI/CQI report may be encoded using type A or type B block codes. For example, if the composite PCI/CQI report is 10 bits, then WTRU may encode the composite PCI/CQI report using a type A, e.g., (20,10) block code. If the composite PCI/CQI report is 7 bits, the WTRU may encode the report using a type B, e.g., (20,7) block code.

In an embodiment, the channel that the HS-DPCCH may be carried on a channel with a SF equal to 128. As such, 40 coded bits may be available for transmission of composite PCI/CQI report in an HS-DPCCH subframe. The WTRU may transmit the composite PCI/CQI report for up to 2 cells on each subframe. The composite PCI/CQI report may be transmitted using time division multiplexing (TDM), when more than two HS-DSCH cells are activated simultaneously.

In 4DL-MIMO operations, the WTRU may be configured to receive up to four streams simultaneously. These streams may be transmitted on appropriate eigenmodes of the channel. The WTRU may transmit the CSI for the channel back to the Node-B. The CSI report may include one or more of a precoding indication such as an index to a matrix or vector, or precoding table, a rank indication and/or one or more CQI. Once received, the CSI report may be interpreted by the Node-B. The Node-B may select a transmission mode based on the CSI report.

As the number of antennas increases, the amount of feedback information may increase. For example, the amount of CSI information associated with the downlink MIMO streams may increase with the increase in the number of antennas. The increase in the amount of CSI information may, in turn, result from increases in amounts of PCI and RI associated with the increase in the number of antennas. Depending on a maximum number of transport block allowed in a single transmission time interval (TTI), the feedback load for transmitting CQI(s) may also increase. In an embodiment, the feedback information may be provided at a reasonable cost in terms of feedback load while enabling downlink gains realized from the downlink MIMO streams, such as 4DL-MIMO.

In an embodiment, feedback information may be provided for each layer of the 4DL MIMO operations. A single precoding matrix or multiple precoding codebooks may be used for coding the feedback information. In an embodiment, feedback information may be provided for up to two codewords. In an embodiment, feedback information may be provided for more than two codewords.

In the description that follows, a number of methods related to providing feedback to the Node-B for use of with a plurality of downlink MIMO operations are described. For convenience, such methods are described with reference to the 4DL MIMO operations (e.g., 4 MIMO streams). The methods, however, may be carried out using other MIMO operations and/or more or less MIMO streams. Further, in the description that follows, a number of methods to report channel information are described herein. The methods may be used in any order and/or combination.

For simplicity of exposition, in the following, the size of a PCI reported is referred to as Ncdbk, which is assumed herein to be Ncdbk=16 or 4 bits. Further, the terms “precoding control information” and its abbreviation “PCI” are synonymous with the terms “precoding information.” In addition, PCI may include precoding matrix information (PMI). The term “channel state information” (CSI) may refer to one or more of, channel quality indicator (CQI), rank indicator (RI), precoding control indication (PCI), precoding matrix indication (PMI), and/or other related channel information.

In an embodiment, channel feedback information for up to two transport blocks (TBs) may be provided in a feedback cycle. A CQI portion may be provided for a TB. Feedback information associated with a TB or a codeword may be transmitted. A codeword may include one or two TBs and may be transmitted using one or two layers. Feedback report of multiple CQI report types may be transmitted in time-alternation. For example, a first type of CQI report may carry information for more than one TB.

In an embodiment, CQI and PMR/RI may be encoded separately. CQI and PMR/RI may be transmitted on separate HS-DPCCH subframes.

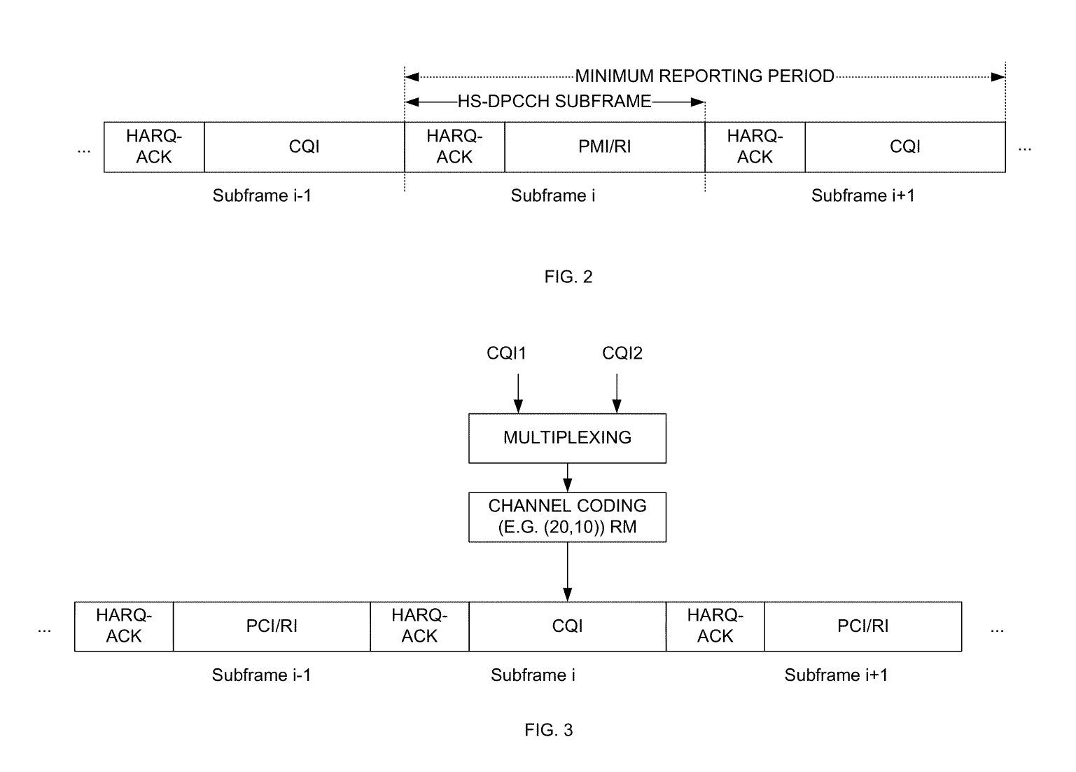

FIG. 2 is a block diagram illustrating example HS-DPCCH subframes for reporting channel information for TBs transmitted via the multiple downlink MIMO streams. As shown, a CSI feedback cycle may include two HS-DPCCH subframes, such as subframe i and subframe i+1. A subframe may include three transmission slots. As shown, the HS-DPCCH subframe i may include a HARQ-ACK and a first encoded portion of the feedback information. The first encoded portion may include, for example, a combination of the PCI and RI associated with the TBs. The first encoded portion may be transmitted in, for example, the second and third slots of the HS-DPCCH subframe i. The HS-DPCCH subframe i+1 may include a HARQ-ACK and a second portion of the of the channel information. The second encoded portion may include, for example, the CQIs associated with TBs. The second encoded portion may be transmitted in, for example, the second and third slots of the HS-DPCCH subframe i+1. The HS-DPCCH subframes i and i+1 carrying the first and second encoded portions may define a minimum channel reporting period (or CSI feedback cycle). The period may include, for example, 4 milliseconds (ms) (once every two 2 ms TTI).

In an embodiment, the WTRU may generate a CSI report for a TB. The CSI may include CQI, PCI and RI. The WTRU may combine the PCI and RI (PCI/RI), and encode the PCI/RI and the CQI separately to form the first and second encoded portions. The WTRU may send the first and second encoded portions in separate HS-DPCCH subframes. For example and as shown in FIG. 2, the first encoded portion that may include PCI/RI may be sent in HS-DPCCH subframe i and the second encoded portion that may include CQI may be sent in HS-DPCCH subframe i+1. The WTRU may transmit the first and second parts using, for example, a HS-DPCCH slot format 0.

The WTRU may encode the CQI using a CQI type A format. The WTRU may encode the PCI/RI and CQI using respective block codes. In an embodiment, the PCI/RI block code may be smaller than the CQI block code due to the PCI/RI including fewer bits than the CQI. In addition, the first and second encoded portions may require a lower combined code rate than a combined code rate for two composite PCI/CQI reports, which, for example, may use block code (20,10) for PCI/CQI type A reporting.

The WTRU may encode CQI and PCI/RI of different bit lengths using different codes (e.g., block codes). The first and second encoded portions may have different code rates. Depending on desired target error rates for such first and second encoded portions, the WTRU may be configured to transmit the first and second encoded portions with different power offsets. For example, the WTRU may be configured with separate power offsets for the encoded CQI and PCI/RI. The configuration may be accomplished via radio resource control (RRC) signaling, for instance.

In an embodiment, the WTRU may encode the CQI using a report format such as CQI type A format. The WTRU may implicitly indicate the number of TBs as a function of the number of CQI(s) reported. In an embodiment, the WTRU may multiplex two independent CQIs and jointly encode the CQIs with a (20, 10) code.

FIG. 3 illustrates example multiplexing CQIs in a HS-DPCCH subframe. As shown, the WTRU may multiplex two independent CQIs such as CQI1 and CQI2 in a HS-DPCCH subframe such as HS-DPCCH subframe i. Each CQI may include for example, 5 bits. The WTRU may jointly encode the CQIs with a block code such as, but not limited to, a (20,10) block code.

The WTRU may transmit the encoded CQIs in slot(s) reserved for CQI in the HS-DPCCH subframe. The WTRU and the Node-B may employ various encoding tables for encoding CQI(s) to support multiple layer transmissions and/or TBs that may be larger than conventional TBs.

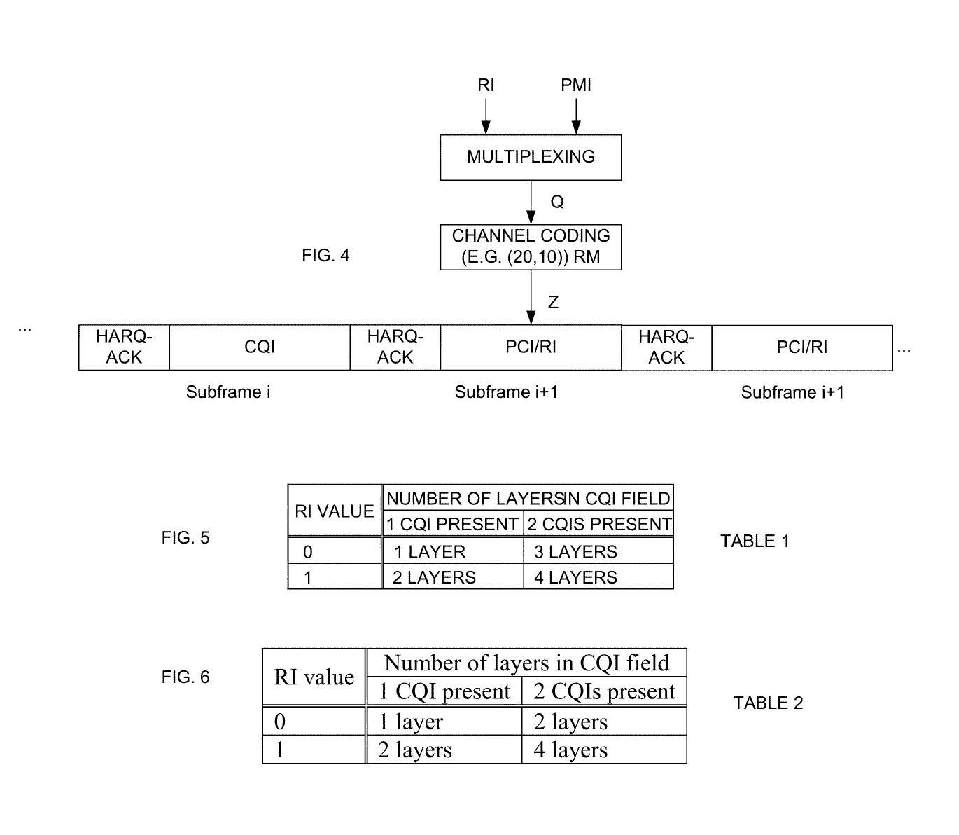

FIG. 4 illustrates an example flow for encoding channel information to facilitate reporting channel information in a HS-DPCCH. As shown in FIG. 4, the WTRU may jointly encode the RI and PMI, for example, using a block code or a subset of a block code. As shown, the WTRU may multiplex the PCI and RI to form, for example, a multiplexed vector, Q. The vector, Q, may include a vector of uncoded multiplexed PCI and RI bits. After multiplexing the PCI and RI, the WTRU may channel code the vector, Q, (e.g., the uncoded multiplexed PCI and RI bits) to form, for example, vector, Z. The vector, Z, may include a vector of coded PCI and RI bits. The WTRU may map the vector, Z, (e.g., the coded PCI and RI bits) to a HS-DPCCH subframe, such as HS-DPCCH subframe i+1.

The WTRU may multiplex the PCI and the RI by concatenating the bits of the RI and the bits of the PCI. The RI may include 2 bits to facilitate reporting of any of rank 1, 2, 3 and 4. The PCI, may include Ncdbk=16 or 4 bits. In combination, the RI bits and PCI bits may include 6 bits. The WTRU may encode the 6 multiplexed PO/RI bits using, for example, a subset of a (20,7) block code for CQI type B reporting. A basis for the (20,7) block code may be selected. The WTRU may encode the multiplexed PCI/RI bits using other codes.

In an embodiment, feedback information may be multiplexed such that a requisite level of protection to a portion of the bits may be achieved. Bits in feedback information may be arranged such that a sensitive portion of such control bits may be provided with a higher level of protection than less sensitive portion of the control bits.

To illustrate, the requisite level of protection may be achieved by arranging the PCI and RI bits such that the most significant bit (MSB) of the PCI and RI requiring the additional protection as the MSB of a multiplexed vector may receive additional protection. A code that provides the requisite level of protection for the MSB of the multiplexed vector may be applied. The CQI and/or other control bits may be arranged for providing protection for the MSB.

In an embodiment, the WTRU may multiplex the PCI an RI bits in such a way as to offer better protection to the RI. For example, the multiplexed vector Q including PCI an RI bits may be formed as follows:

Q=q₀, . . . , q₅=pmi₀, . . . , pmi₃, r₀, r₁,

where an element having a subscript “0” corresponds to the least significant bit (LSB). The MSB of the RI may be aligned with the MSB of the multiplexed PCI/RI bits. When the WTRU uses a code that provides the requisite level of protection to the MSB of vector Q, the MSB of the RI may be provided with the requisite level of protection. For example, the WTRU may apply to the MSB of Q the last column of the block-code basis. By way of example, to encode a total of 6 bits (e.g., the PCI an RI bits), a code such as a subset of the (20,7) codes may be generated using 6 of the 7 basis of the (20,7) code. The subset may include the basis associated to the MSB. For example, the basis for n ε {0,1,3,4,5,10} may be used, and entry 7 may discarded from the (20,7) code, where n may be the basis index.

Rank indication may be provided implicitly. In an embodiment, the rank information may be indicated using a combination of the RI and the number of preferred TB included in the encoded CQI portion of a channel information report. For example, a conditional rank indication may be provided. The RI may be carried using a single bit. For example, the WTRU may determine the channel state information such as RI, PCI, and associated CQI for a TB. Based on the number of transport blocks to report, the WTRU may select a value for representing the RI. For example, the WTRU may select value of the single RI bit according to a set of rules and the number of TBs to be reported. The WTRU may select the representation of RI (e.g., an RI value) based on entries in Table 1 shown in FIG. 5. For example, when a CQI is present in the feedback report, the WTRU may use value 0 for indicating 1 layer or rank-1, and value 1 for indicating 2 layers or rank-2. When two CQIs are present in the feedback report, the WTRU may use value 0 for indicating 3 layers or rank-3, and value 1 for indicating 4 layers or rank-4. The WTRU may select report feedback for 1, 2 and 4 layers for 1 and 2 CQIs by selecting the representation of RI (e.g., an RI value) based on entries in Table 2 shown in FIG. 6. As shown, when a CQI is present in the feedback report, the WTRU may use value 0 for indicating 1 layer or rank-1, and value 1 for indicating 2 layers or rank-2. When two CQIs are present in the feedback report, the WTRU may use value 0 for indicating 2 layers or rank-2, and value 1 for indicating 4 layers or rank-4.

As described above, when providing a conditional rank indication, the WTRU may report the RI using a single bit. When PCI includes 4 bits, the WTRU may use a (20,5) block code to encode the PCI and the representation of RI. The WTRU may use a subset of the (20,7) block code, keeping the last column in the list of basis for the MSB to offer additional error protection. As the representation of RI is conditional on the CQI report, the additional error coding protection may be provided to the PCI MSB.

In an embodiment, the RI may be embedded in a CQI report. For example, the RI or a representation of RI may be embedded into the CQI. The CQI report for up to a rank 4 transmission of a 4-branch DL MIMO may be constructed as follows:

$$CQI = \{ \begin{matrix}{CQI}_{s} , & \begin{matrix}when 1 transport block and rank 1 are \\ preferred by the WTRU\end{matrix} \\ {CQI}_{s} + 481 , & \begin{matrix}when 1 transport block and rank 2 are \\ preferred by the WTRU\end{matrix} \\ 15 \times {CQI}_{1} + {CQI}_{2} + 31 , & \begin{matrix}when 2 transport blocks and rank 2 \\ are preferred by the WTRU\end{matrix} \\ 15 \times {CQI}_{1} + {CQI}_{2} + 256 , & \begin{matrix}when 2 transport blocks and rank 4 \\ are preferred by the WTRU\end{matrix}\end{matrix}$$

where without losing generality, the value of CQIₛ for a single TB transmission may vary from 0 to 30, and the values of each of CQI₁ and CQI₂ for each TB for dual transport blocks transmission may vary from 0 to 14. The BS can get the rank information after decoding CQI as constructed above.

For example, the CQI report can be constructed as follows:

$$CQI = \{ \begin{matrix}{CQI}_{s} , & \begin{matrix}when 1 transport block and rank 1 are \\ preferred by the WTRU\end{matrix} \\ {CQI}_{s} + 481 , & \begin{matrix}when 1 transport block and rank 2 are \\ preferred by the WTRU\end{matrix} \\ 15 \times {CQI}_{1} + {CQI}_{2} + 31 , & \begin{matrix}when 2 transport blocks and rank 3 \\ are preferred by the WTRU\end{matrix} \\ 15 \times {CQI}_{1} + {CQI}_{2} + 256 , & \begin{matrix}when 2 transport blocks and rank 4 \\ are preferred by the WTRU\end{matrix}\end{matrix}$$

While the CQI report constructions shown above assumes 9 bits are sufficient to represent CQI, the principle described herein applies to CQI of any number of bits. To support 2 TBs, when the rank of channel is 2, the CQI report may be constructed as follows:

$$CQI = \{ \begin{matrix}{CQI}_{s} , & \begin{matrix}when 1 transport block and rank 1 are \\ preferred by the WTRU\end{matrix} \\ 15 \times {CQI}_{1} + {CQI}_{2} + 31 , & \begin{matrix}when 2 transport blocks and rank 2 are \\ preferred by the WTRU\end{matrix} \\ 15 \times {CQI}_{1} + {CQI}_{2} + 256 , & \begin{matrix}when 2 transport blocks and rank 3 \\ are preferred by the WTRU\end{matrix} \\ 15 \times {CQI}_{1} + {CQI}_{2} + 481 , & \begin{matrix}when 1 transport block and rank 4 \\ are preferred by the WTRU\end{matrix}\end{matrix}$$

In this construction, the CQI may include 10 bits.

When the CQI value is greater than 705, the CQI may be used to signal single or multiple control information other than, or in addition to CQI and rank. The construction for such CQI is as follows:

$$CQI = \{ \begin{matrix}{CQI}_{s} , & \begin{matrix}when 1 transport block and rank 1 are \\ preferred by the WTRU\end{matrix} \\ 15 \times {CQI}_{1} + {CQI}_{2} + 31 , & \begin{matrix}when 2 transport blocks and rank 2 are \\ preferred by the WTRU\end{matrix} \\ 15 \times {CQI}_{1} + {CQI}_{2} + 256 , & \begin{matrix}when 2 transport blocks and rank 3 \\ are preferred by the WTRU\end{matrix} \\ 15 \times {CQI}_{1} + {CQI}_{2} + 481 , & \begin{matrix}when 1 transport block and rank 4 \\ are preferred by the WTRU\end{matrix} \\ 705 < CQI < 1023 , & \begin{matrix}Other control information to be \\ signalled by the WTRU\end{matrix}\end{matrix}$$

In an example, CQI values between 706 and 1023 may be used to signal the PMI/PCI. In an example, CQI values between 706 and 1023 may be used to signal the PMI/PCI of long-term precoding codebook, while the PMI/PCI of the short-term precoding codebook may be signaled using a R7 codebook reporting approach.

The WTRU may be configured to carry the rank and/or other control information via the CQI index. For example, a CQI table may include entries such as transport block size, number of HS-PDSCH, modulation, reference power adjustment, NIR and/or Xrv, for a CQI value or index.

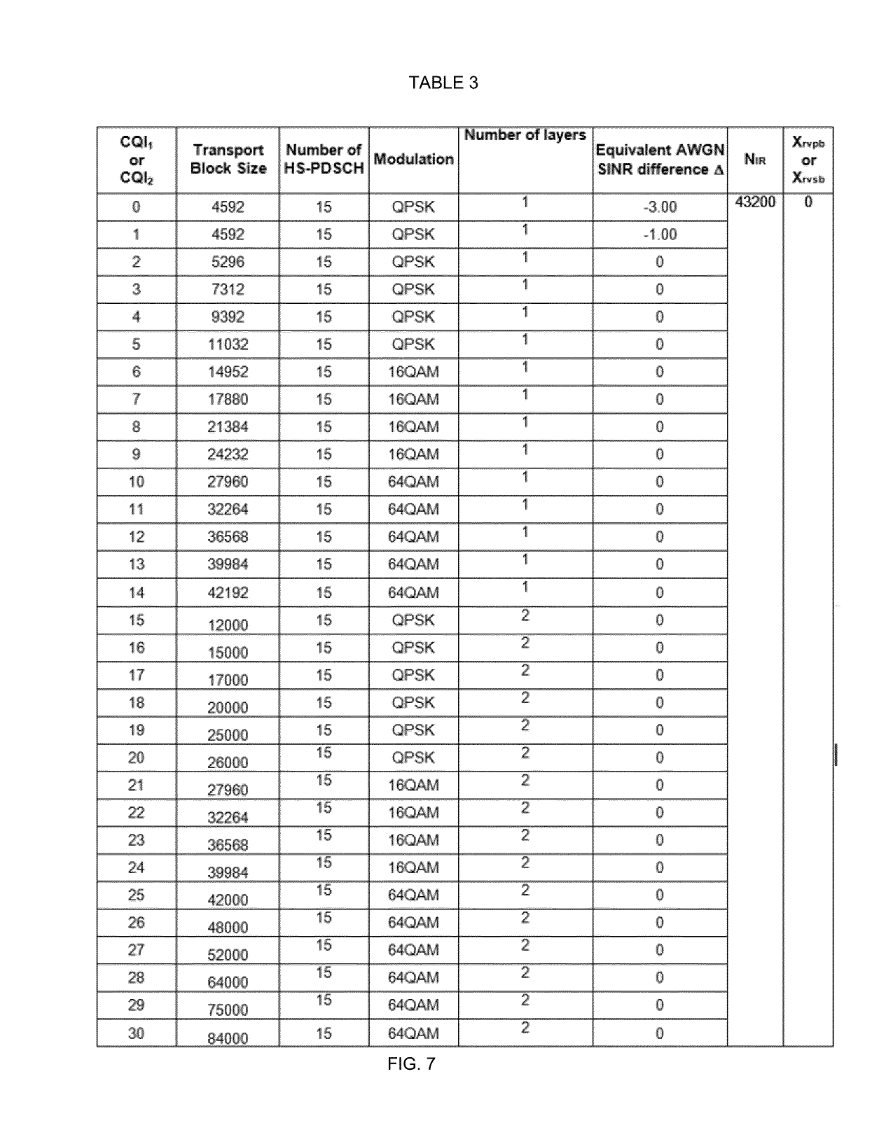

In an example, the WTRU may report a CQI per codeword. Two CQI reports may be transmitted for reporting for up to 2 codewords. The WTRU may be configured with an extended CQI table. The extended CQI table may contain additional information entries associated to one or more CQI indexes. The additional information entries may include, but not limited to, one or more of (in any order or combination), the rank information for a specific CQI, the number of High Speed-Physical Downlink Shared Channel (HS-PDSCH) for the second layer, the modulation for the second layer, the reference power adjustment for the second layer, or the joint reference power adjustment (for one or multiple layers simultaneously). An example extended table is illustrated in FIG. 7.

In an embodiment, the WTRU may determine a preferred rank based on the receive rate associated with the rank. For example, the preferred rank may be selected based on the maximum transport block size (TBS) the WTRU may receive conditioned on the rank. For instance, the WTRU may determine that with rank-1, the WTRU may receive 100 bits per TB, and with rank-2, 200 bits per TB, and with rank-3, 150 bits per TB. The WTRU may determine rank-2 as the preferred rank and may report 200 bits as the associated CQI.

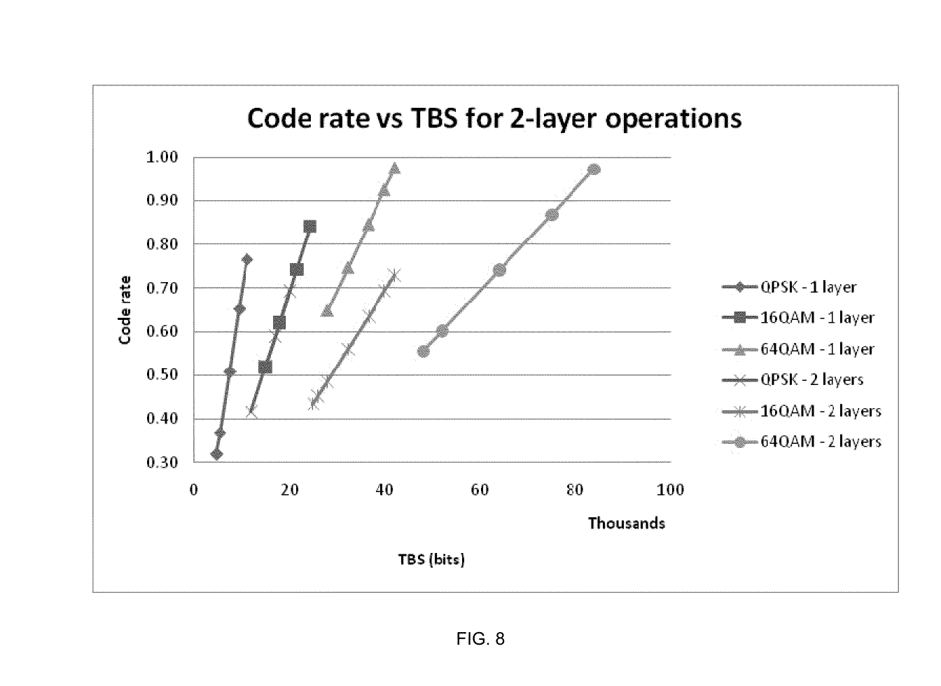

FIG. 8 shows an example of code rate as a function of the TBS for difference modulation and number of layers. As shown in FIG. 7 and FIG. 8, the WTRU may be configured with overlapping transport blocks sizes or transport block sizes ranges. In this manner, for the overlapping TBS or range of TBS, the WTRU may report, based on channel conditions, whether it is more efficient to receive using 1 or 2 layers.

As shown in FIG. 8, the WTRU may choose the TBS, the modulation and/or number of layer or rank scheme, and may report the scheme along with the CQI. The WTRU may be configured with an extended CQI table and may be configured to report the highest CQI the WTRU can support, and a combination of highest CQI and modulation or number of layer or rank scheme via the CQI index value. More specifically, the WTRU may be configured to report the CQI index corresponding to the largest TBS that the WTRU could receive with a probability of error less than 10% on the first transmission.

The WTRU may report the CQI value leading to the largest supported TBS. In case multiple CQI values (e.g. the same TBS but different rank) lead to the same TBS, the WTRU may be configured to report the CQI value with the lowest rank. The WTRU may be configured with an SNR penalty to apply when calculating CQI for rank-2 transmission. The WTRU may be configured to report the CQI value requiring the least amount of receive energy, or the most efficient CQI value.

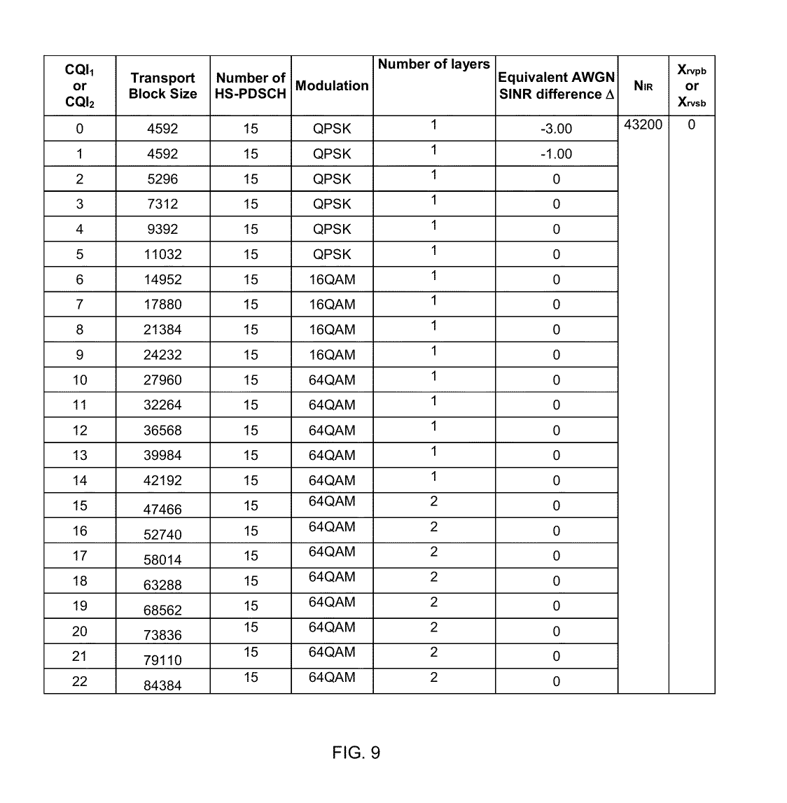

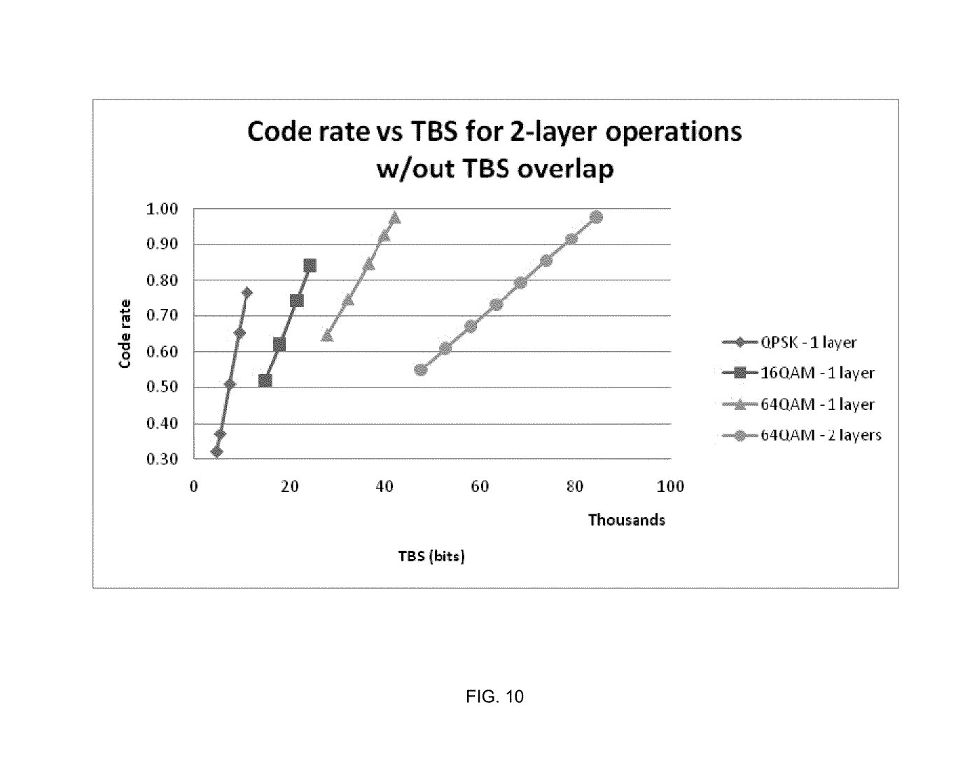

In an embodiment, the TBS values in the extended CQI table may not overlap, and the WTRU may not need to determine the number of layers to report. FIG. 9 illustrates an example extended CQI table without overlapping. FIG. 10 illustrates example code rate vs. TBS relationship with no TBS overlap.

The WTRU may be configured with a CQI table that may include values supported with 2 layers. The WTRU may be configured with a threshold index indicating the CQI index above which the number of layers is 2, regardless of whether the TBS may fit in a single layer. This approach may provide configuration flexibility for the network and may allow the WTRU to report a preference for rank-2 transmission for a TB, when the TBS corresponding to the CQI value reported may be supported using rank-1 transmission.

The WTRU may be configured with a SNR difference (e.g. in dB) for rank-2 transmission. For example, the WTRU may be configured with a SNR difference for CQI values above the configured threshold. The SNR difference may be statically or dynamically configured by the network. The SNR difference may be a preset value.

The WTRU implementation may dictate the value of one or more of the threshold(s) and additional SNR difference parameter(s). The WTRU may inform the network of the threshold(s) and additional SNR difference parameter(s), for example, via RRC signaling.

In an embodiment, the WTRU may jointly encode CSI. The coded bits may be transmitted in multiple HS-DPCCH subframes, such as two HS-DPCCH subframes. The WTRU may multiplex the CQI(s), PCI and RI information to form multiplexed information, and apply channel coding to the multiplexed information to form encoded multiplexed information, followed by de-multiplexing the encoded multiplexed information into two separate sets of encoded multiplexed information (e.g., coded bits) for transmission.

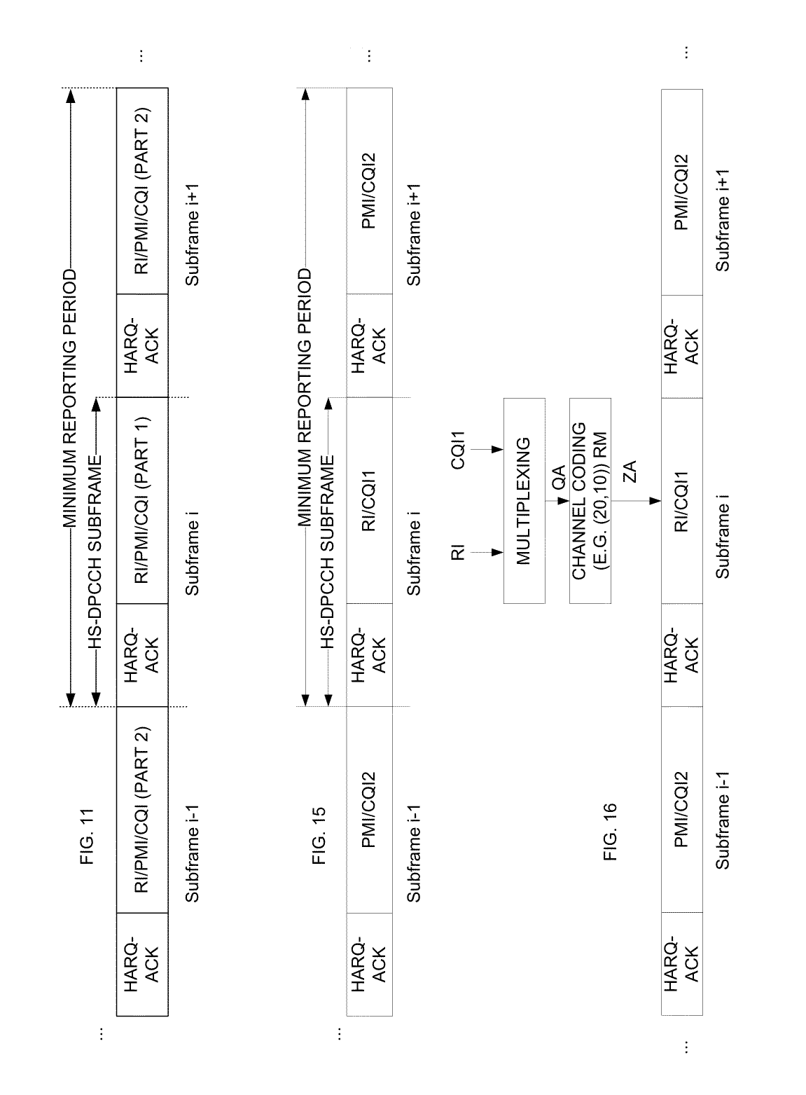

FIG. 11 illustrates an example transmission of joint RI/PMI/CQI across adjacent HS-DPCCH subframes. As shown in FIG. 11, coded bits may be transmitted in HS-DPCCH subframes i and i+1. Transmitting CSI in two HS-DPCCH subframes may result in a minimum reporting period of 4 ms or two 2 ms TTIs. The WTRU may be configured to transmit the two related set of coded bits over adjacent HS-DPCCH subframes.

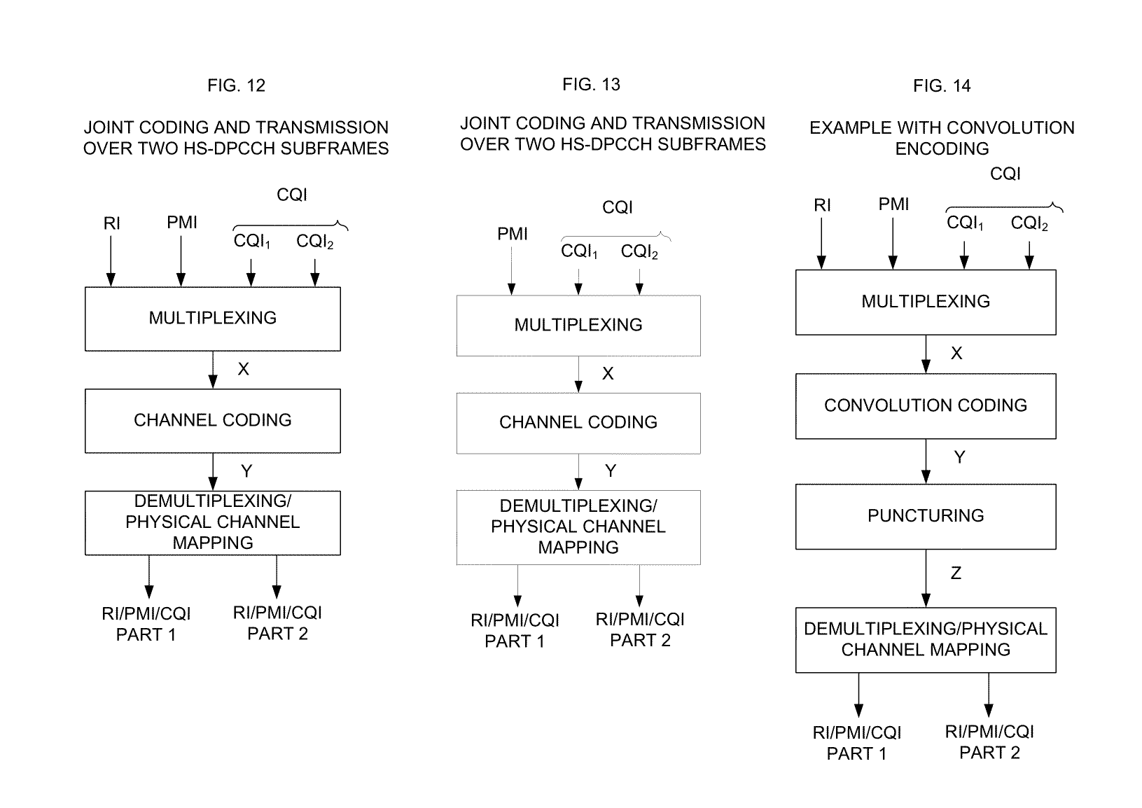

FIG. 12 illustrates example joint coding and transmission over two HS-DPCCH subframes. As shown in FIG. 12, RI, PMI, and the CQI(s) such as CQI₁ and CQI₂ may be multiplexed to form uncoded control information “X.” The uncoded control information X may be encoded to form coded channel information “Y.” The length of Y may correspond to a length of two conventional PCI/CQI fields in the HS-DPCCH. The coded channel information Y may include 40 symbols for HS-DPCCH slot format 0 and 80 symbols for HS-DPCCH slot format 1.

FIG. 13 illustrates example joint coding and transmission over two HS-DPCCH subframes. In an embodiment, the rank indication is implicitly provided, and the RI may not be jointly coded with PMI and CQI. The rank indication may be carried implicitly, for example using one of the approaches described above. When RI is not present, the PMI and CQI(s) may be multiplexed and jointly coded as illustrated in FIG. 13.

The WTRU may carry out multiplexing in any particular order. Certain channel coding techniques offer uneven protection between bits, such as the block codes used for CQI encoding. The MSB of the CQI may benefit from the additional error protection by placing it at the end of a multiplexed control block.

For example, the RI may include 2 bits such as (r=r₀, r₁), the PMI may include 4 bits such as (pmi=pmi₀, . . . , pmi₃), and the CQI may include 8 bits as in type A such as (cqi=cqi₀, . . . , cqi₇). For illustrative purposes, bit 0 of a field may be the LSB, and the bit with the largest bit index may be the MSB. For example, bit cqi₇ may be the MSB for the CQI field. The multiplexed control bits may be expressed as follows:

X=x₀, . . . , x_{L-1}=r₀, r₁, pmi₀, . . . , pmi₃, cqi₀, . . . , cqi₇,

where L may represent the total length of X. For example, L may equal to 14, and bit L−1 may be the MSB of X.

In an embodiment, the control information may be multiplexed such that the MSB(s) of the RI and CQI are provided with a higher level of protection than the other bit(s). For example, the control information may be multiplexed with the assumption that two separate code blocks with unequal error protection may be used. The MSB(s) of the RI and CQI may be arranged in such a way that the MSB(s) may be better protected.

When the rank information is implicitly indicated based on the CQI value, the WTRU may encode the CQI field so as to offer the additional protection. The PMI may include 4 bits such as (pmi=pmi₀, . . . , pmi₃), and the CQI may include 8 bits as in type A such as (cqi=cqi₀, . . . , cqi₇). The multiplexed control bits may be expressed as follows:

X=x₀, . . . , x_{L-1}=pmi₀, . . . , pmi₃, cqi₀, . . . , cqi₇,

where L may represent the total length of X. For example, L may equal to 12, and bit L−1 may be the MSB of X.

In an embodiment, additional protection may be applied to the PMI field. The multiplexed control bits may be expressed as follows:

X=x₀, . . . , x_{L-1}=cqi₀, . . . , cqi₇, pmi₀, . . . , pmi₃

where L may represent the total length of X. For example, L may equal to 12, and bit L−1 may be the MSB of X.

FIG. 14 illustrates an example joint coding using convolution coding. As shown, the WTRU may apply channel coding to the control bits X to obtain the coded block Y. The WTRU may use a number of channel coding options. As shown in FIG. 14, the coded block Y may be punctured. For example, the WTRU may be configured with and may use a coder in combination with puncturing to encode the control bits into a 40 bit codeword.

For illustrative purposes, transmission over two HS-DPCCH subframes with slot format 0 and a (40,14) block code are assumed. The approaches described herein may apply to transmission over other number of HS-DPCCH subframes with other slot format, using other block code(s).

By way of example, the WTRU may encode the control bits using a rate ½ convolutional encoder to form a 44-bit codeword. The WTRU may apply puncturing to reduce the length of the codeword to 40 bits for transmission over the channel. For example, the first 2 and last 2 coded bits from the codeword may be punctured. For example, coded bits that may carry less information than other bits may be punctured. The bits to be punctured may be selected based on an analysis of simulations, for example. This concept may be applied, for example, when the RI field is not present and/or with fields of different length.

In an example, the WTRU may encode the control bits using the conventional rate ⅓ convolutional encoder to form a 66-bit codeword. The WTRU may apply puncturing to reduce the length of the codeword to 40 bits for transmission over the channel. In an embodiment, the punctured bits location may be pre-defined. In an embodiment, the punctured bits location may be dynamically signaled to the WTRU, for example, via RRC signaling.

In an embodiment, interleaving may be applied to the coded bits. Among other things, interleaving may mitigate impact of short burst of interference that may be caused by transmitting a codeword over two HS-DPCCH subframes. Interleaving may be applied to where the even and odd bits from the punctured codeword may be separated over the two subframes.

Time division multiplexing (TDM) with partial joint coding of feedback parameters and explicit rank indication may be used for providing feedback for multilink MIMO streams. The WTRU may report the feedback over two or more HS-DPCCH subframes. The WTRU may transmit feedback information that may include RI, PMI, and/or CQI for an associated preferred rank. The WTRU may transmit the CQI for up to two codewords. In an embodiment, a codeword may include up to two TBs. In an embodiment, a codeword may include more than two TBs.

For illustrative purposes, it may be assumed that the RI may include 2 bits, for example, for indicating the number of layers. The PMI may include 4 bits, for example, for a codebook of up to 16 entries. The WTRU may transmit a CQI for a codeword using 4 bits or 5 bits. However, the approach(es) described herein may apply to RI, PMI and CQI with other number of bits.

In an embodiment, the feedback information may include 16 bits. For example, the feedback information may include a RI having 2 bits, a PMI having 4 bits; a CQI₁ having 5 bits; a CQI₂ having 5 bits, where the CQI₁ may include the CQI for a first codeword, and the CQI₁ may include the CQI for a second codeword. The feedback information may be multiplexed using a TDM approach.

For example, the RI and CQI₁ may be jointly coded and transmitted in a first HS-DPCCH subframe. The PMI and CQI₂ may be jointly coded and transmitted in a second HS-DPCCH subframe. For example, the RI and PMI may be jointly coded and transmitted a first HS-DPCCH subframe, and the CQI₁ and CQI₂ may be jointly coded and transmitted a second HS-DPCCH subframe.

FIG. 15 illustrates example subframes of HS-DPCCH carrying feedback information using a TDM approach with partially joint coding. As shown in FIG. 15, feedback information may be transmitted in two adjacent subframes such as subframe i and subframe i+1. Subframe i may carry the RI/CQI₁, and subframe i+1 may carry the PMI/CQI₂. The minimum CQI feedback cycle or reporting period may be 4 ms or 2 TTIs. The combined report, including RI/CQI₁ and PMI/CQI₂ are referred to as the composite extended type A report herein.

FIG. 16 illustrates example multiplexing and coding for feedback information using a TDM approach with partially joint coding. As shown, RI and CQI₁ may be multiplexed to form a vector of uncoded multiplexed RI and CQI bits, Qa. Vector Qa may include 7 bits, and may be coded using a subset of the channel coding for HS-DPCCH. For example, a subset of a (20,10) code. As shown, the joint coding to produce a vector of coded RI and CQI bits, Za. The report including PCI and RI bits is referred to as the composite RI/CQI report or as part 1 of the composite extended type A report herein.

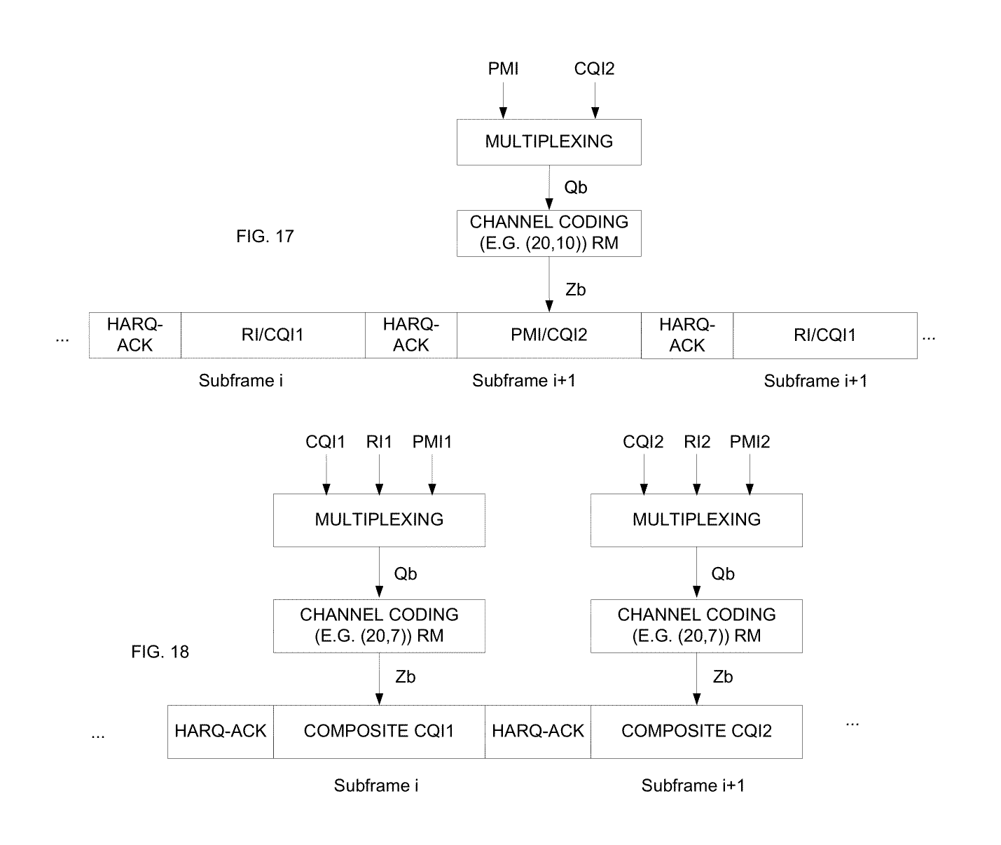

FIG. 17 illustrates example multiplexing and coding for feedback information using a TDM approach with partially joint coding. As shown, PMI and CQI₂ may be multiplexed to form a vector of uncoded multiplexed PMI and CQI bits, Qb. Vector Qb may include 9 bits, and may be coded using a subset of the channel coding for HS-DPCCH. For example, a subset of a (20,10) code. As shown, the joint coding to produce a vector of coded PCI and RI bits, Za. The report including PMI and CQI bits is referred to as the composite PMI/CQI report or as part 2 of the composite extended type A report herein.

Different power offset may be applied to the composite PMI/CQI report and the composite PMI/CQI report. The two types of composite CQI reports may have different field length. For example, the vector Qa may include 7 bits, and the vector Qb may include 9 bits. The two types of composite CQI reports may have different code rates when being encoded to the 20 bit field into a subframe. Applying different power offsets to the corresponding HS-DPCCH fields may equalize demodulation/decoding performance at a receiver. For example, as a means for boosting power for the composite PMI/CQI report, the entry to a power table may be moved up one or more steps with reference to that of the RI/CQI report.

In an embodiment, the WTRU may generate a first composite CQI report that may include CQI associated with a first codeword, and a second composite CQI report that may include CQI associated with a second codeword. The WTRU may generate a PMI, and may split the PMI into two parts. The first composite CQI report may be multiplexed and jointly coded with a first part of the PMI, and the second composite CQI report may be multiplexed and jointly coded with a second part of the PMI. The WTRU may transmit the encoded report that may include CQI associated with the first codeword and the encoded report that may include CQI associated with the second codeword in separate subframes. In an embodiment, the preferred rank, RI associated with a codeword may be embedded in to the corresponding composite CQI report. In an embodiment, the preferred rank, RI associated with a codeword may be explicitly provided and may be multiplexed and jointly coded with the corresponding composite CQI report.

FIG. 18 illustrates example multiplexing and coding for feedback information using a TDM approach with partially joint coding. As shown, a first composite CQI report such as composite CQI₁ may be carried in a first subframe such as subframe i, and a second composite CQI report such as composite CQI₂ in a second subframe such as subframe i+1. The two composite CQI reports in the two consecutive subframes may have the same length. For example, the RI may be split into two parts such as RI₁=r₀, which may be used to indicate preferred number of layers for a first codeword, and RI₂=r₁, which may be used to indicate preferred number of layers for a second codeword. The PMI may be split into two parts such as PMI1=pmi₀pmi₁ and PMI2=pmi₂ pmi₃. The composite CQI reports may be coded with equal coding rates.

For example, the bit fields of the two subframes may be arranged such that a first subframe may carry feedback information associated with a first codeword, and a second subframe may carry feedback information associated with a second codeword. For example, the ith subframe may include cqi_{0,0}cqi_{0,1}cqi_{0,2}cqi_{0,3}r₀pmi₀pmi₁, and the (i+1)th subframe may include cqi_{1,0}cqi₁₁cqi_{1,2}cqi_{1,3}r₁ pmi₂ pmi₃, where cqi_{l,k} may be the k^{th} bit for the CQI associated to codeword #l, and a CQI report may include 4 bits. The bits may be arranged in any order.

For example, a (20,10) code may be used. The ith subframe may include cqi_{—}0,0 cqi_{—}0,1 cqi_{—}0,2 cqi_{—}0,3 cqi_{—}0,4 r_{—}0 pmi_{—}0 pmi_{—}1 pmi_{—}2 pmi_{—}3 and the (i+1)th subframe may include qi_{—}1,0 cqi_{—}1,1 cqi_{—}1,2 cqi_{—}1,3 cqi_{—}1,3 r_{—}1 pmi_{—}0 pmi_{—}1 pmi_{—}2 pmi_{—}3, where cqi_{l,k} may be the k^{th} bit for the CQI associated to codeword #l, and a CQI report may include 5 bits. The bits may be arranged in any order.

FIG. 34 illustrates an example of multiplexing and coding for feedback information using a TDM approach with partially joint coding. As shown, a first composite CQI report such as composite CQI₁ may be carried in a first subframe such as subframe i, and a second composite CQI report such as composite CQI₂ in a second subframe such as subframe i+1. The two composite reports may be carried in two consecutive subframes. The composite CQI reports may have the same length and may carry rank indication implicitly. The PMI may be split into two parts such as PMI1=pmi₀pmi₁ and PMI2=pmi₂ pmi₃. The composite CQI reports may be coded with equal coding rates.

For example, the bit fields of the two subframes may be arranged such that a first subframe may carry feedback information associated with a first codeword, and a second subframe may carry feedback information associated with a second codeword. For example, the ith subframe may include cqi_{0,0}cqi_{0,1}cqi_{0,2}cqi_{0,3}cqi_{0,4}pmi₀pmi₁, and the (i+1)th subframe may include cqi_{1,0}cqi_{1,1}cqi_{1,2}cqi_{1,3}cqi_{1,4}pmi₂pmi₃, where cqi_{l,k} may be the k^{th} bit for the CQI associated to codeword #l, and a CQI report may include 5 bits. The bits may be arranged in any order. The Reed-Muller (20,7) code may be used to encode the control information in each subframe separately.

In an embodiment, the WTRU may code the feedback information using codes that may provide uneven error protection. The bits may be arranged such that the bits in RI, PMI and the MSB of the CQI may be better protected in the other bits in the report.

In an embodiment, feedback reports may be configured to periodically provide precoding control information and CQI for less than highest supported rank(s). The CSI report may indicate a recommendation to the base station, and the base station may or may not follow such recommendation. The WTRU may, for example, include a recommendation to the Node-B for using a less aggressive transmission scheme. The WTRU may devise such channel report by providing the PCI/PMI for a rank less than its highest supported rank. A WTRU may support a specific rank if equipped with hardware that may support the rank, and/or if the WTRU determines that the WTRU may reliably receive data under current channel condition using the rank. In an example, WTRU hardware may support reception of up to 4 layers (rank-4), and the WTRU may determine that the current channel conditions may only allow for rank-2 transmission. The WTRU may be considered to support rank-2 transmission. For example, a WTRU may provide the PMI for rank-1 or rank-2 transmission while supporting rank-4 transmission. For example, a base station may configure the WTRU to provide low rank reports, and may select a MIMO transmission mode based on a received low rank report. The base station may receive the CSI, and determine whether to adopt the recommended lower rank. When the base station rejects the recommendation to use the lower rank, the base station may use other feedback provided to the Node-B from the WTRU, such as a high-rank report or a type A report, to make an appropriate precoding decision.

To illustrate, in the context of 4-branch MIMO operations, low-rank feedback reports such as feedback reports for rank-1 and/or rank-2 transmission may be provided. The WTRU may be configured to transmit a low-rank feedback at regular intervals, with multiplexing and channel coding for the HS-DPCCH adjusted. For single-stream transmission, the low-rank feedback may include the PMI and associated CQI of the best stream. The CQI may be carried in a type B report.

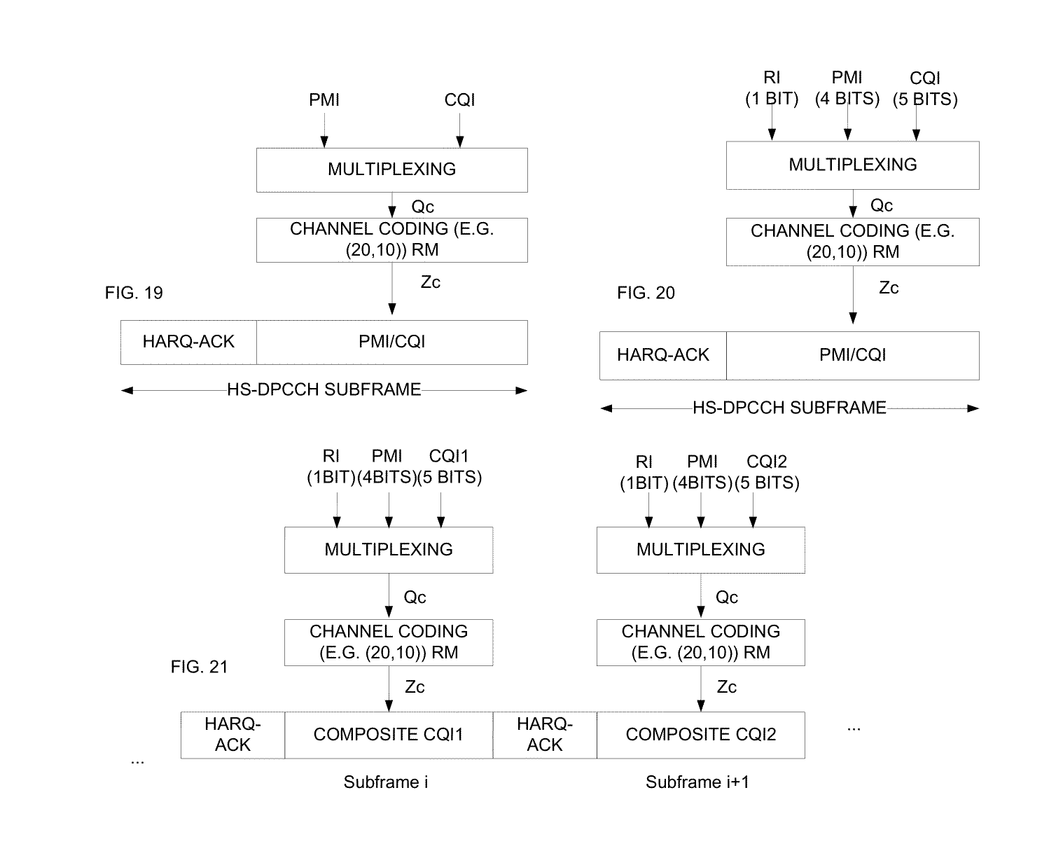

FIG. 19 illustrates example multiplexing and coding for low-rank feedback reporting. As shown, the PMI and the CQI may be multiplexed to form a vector of uncoded multiplexed PMI and CQI bits, Qc. The PMI may include 4 bits, and the CQI may include 5 bits. The total payload may be 9 bits. The vector Qc may be coded using channel coding for HS-DPCCH, or a subset of channel coding for HS-DPCCH, to form a vector of coded PMI and CQI bits. The report including PMI and CQI bits is referred to as rank-1 composite PMI/CQI report or as composite rank-1 extended type B report herein.

In an embodiment, the WTRU may transmit a preferred rank for receiving data in the feedback report. FIG. 33 illustrates an example process for transmitting a low-rank feedback report. At 510, the WTRU may select a preferred HS-PDSCH transmission rank from a subset of supported HS-PDSCH transmission ranks. The subset may include ranks lower than the highest rank supported by the WTRU. To illustrate, in the context of 4-branch MIMO operations, the WTRU may support rank-1, rank-2, rank-3 and rank-4 reception. The subset may include rank-1 and rank-2, and the WTRU may select a preferred HS-PDSCH transmission rank between rank-1 and rank-2. The selection may be based on, for example, the reception rate the WTRU may support for a given rank based on estimated channel conditions. In an embodiment, the rank may be related to transmitting data to the Node-B.

At 520, the WTRU may generate a low-rank feedback report based on the preferred HS-PDSCH transmission rank. The low-rank feedback report may include, a rank indicator, a PMI and one or more CQI. For example, the WTRU may determine the value of the rank indicator, such as the RI field, based on the preferred rank. For example, the rank indicator may take value 1 for rank-2 and value 0 for rank-1 reception. The rank indication may be embedded in an associated CQI report. The WTRU may determine the PMI associated with the preferred rank. The WTRU may determine one or more CQI based on the preferred rank. For example, when the preferred rank is rank-1, the WTRU may report the CQI associated with a stream, such as the stream with the best quality. When the preferred rank is rank-2, the WTRU may report the CQI associated with a second best stream. In an embodiment, when the preferred rank is rank-2, the WTRU may report the CQI associated with the best stream and the CQI associated with a second best stream. The WTRU may determine the appropriate PMI and report the PMI along with the CQI.

At 530, the WTRU may transmit the low-rank feedback report. In an embodiment, the WTRU may transmit the low-rank feedback report in a HS-DPCCH subframe.

The WTRU may transmit multiple types of feedback reports to support 4-branch downlink MIMO for HSDPA. The WTRU may transmit the different types of feedback reports in time alternation with a cycle known to both the WTRU and the Node-B.

In an embodiment, the WTRU may be configured to transmit two types of feedback reports on the HS-DPCCH in time alternation. The first type of feedback report may include the composite extended type A report described herein, for example, with respect to FIG. 15. The composite extended type A report may include multiple parts such as part 1 and part 2 described herein, for example, with respect to FIGS. 16 and 17. The second type of feedback report may include a composite extended type B report. The composite extended type B report may include the composite low-rank extended type B report described herein, for example, with respect to FIG. 19 and/or the composite rank-1 extended type B report described herein, for example, with respect to FIG. 20. Because the minimum reporting period for the extended composite type A report may include 4 ms (2 TTIs) and the minimum reporting period for the composite extended type B report is 2 ms (1 TTI), variations to the feedback reporting cycle may be provided. In an embodiment, the composite rank-1 extended type B report may be transmitted even when the WTRU prefers rank-2 transmission.

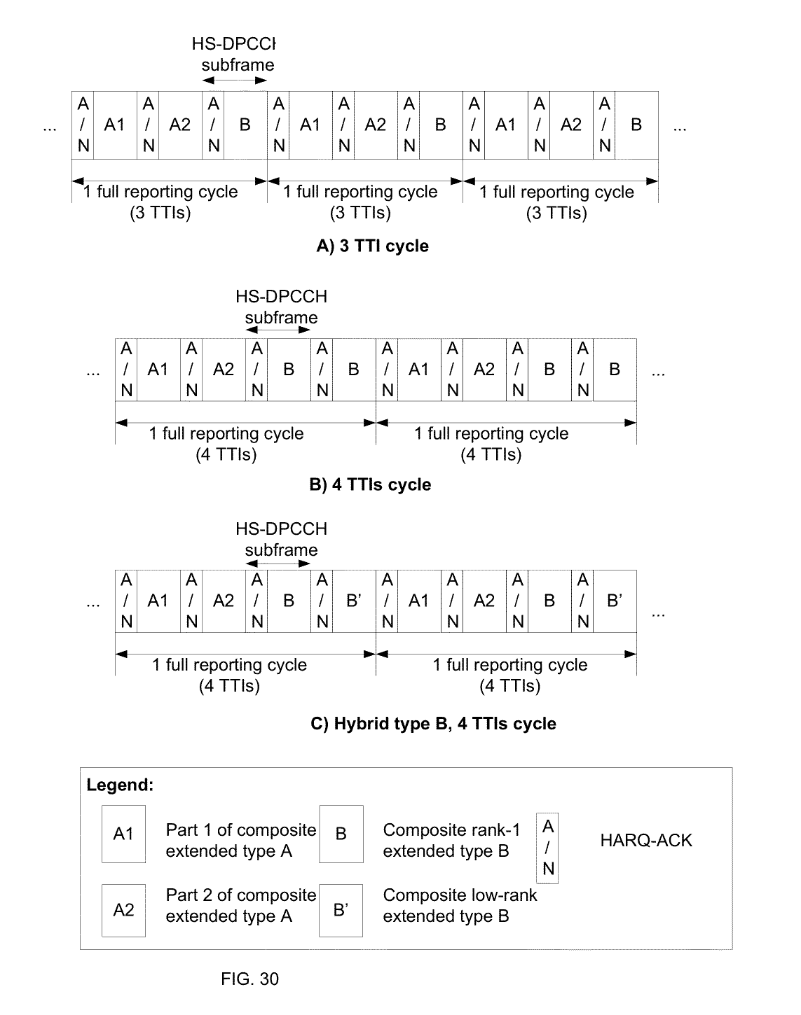

FIG. 30 illustrates example alternate high-rank/low-rank feedback information reporting. As shown in FIG. 30(A), the WTRU may transmit part 1 and part 2 of the composite extended type A report in separate HS-DPCCH subframes. The composite extended type B report may be transmitted in a third HS-DPCCH subframe. The HS-DPCCH subframes may be adjacent to each other. For example, the WTRU may transmit the composite rank-1 extended type B report in the subframe following a subframe carrying the composite extended type A report. The reporting cycle may include 3 TTIs or 6 ms.

As shown in FIG. 30(B), the WTRU may transmit part 1 and part 2 of the composite extended type A report in separate HS-DPCCH subframes. The HS-DPCCH subframes may be adjacent to each other. The WTRU may transmit two composite rank-1 extended type B reports in separate HS-DPCCH subframes. The HS-DPCCH subframes may be adjacent to each other. The full reporting cycle may include 4 TTIs or 8 ms. This approach may allow for a full cycle to complete in an even number of TTIs.

As shown in FIG. 30(C), the WTRU may transmit part 1 and part 2 of the composite extended type A report in separate HS-DPCCH subframes. The HS-DPCCH subframes may be adjacent to each other. The WTRU may transmit a composite rank-1 extended type B report and a composite low-rank extended type B report in separate HS-DPCCH subframes. The HS-DPCCH subframes may be adjacent to each other. The full reporting cycle may include 4 TTIs or 8 ms. This approach may allow for a full cycle to complete in an even number of TTIs, and may allow flexible Node-B scheduling because of the additional channel state information carried in the composite low-rank extended type B report.

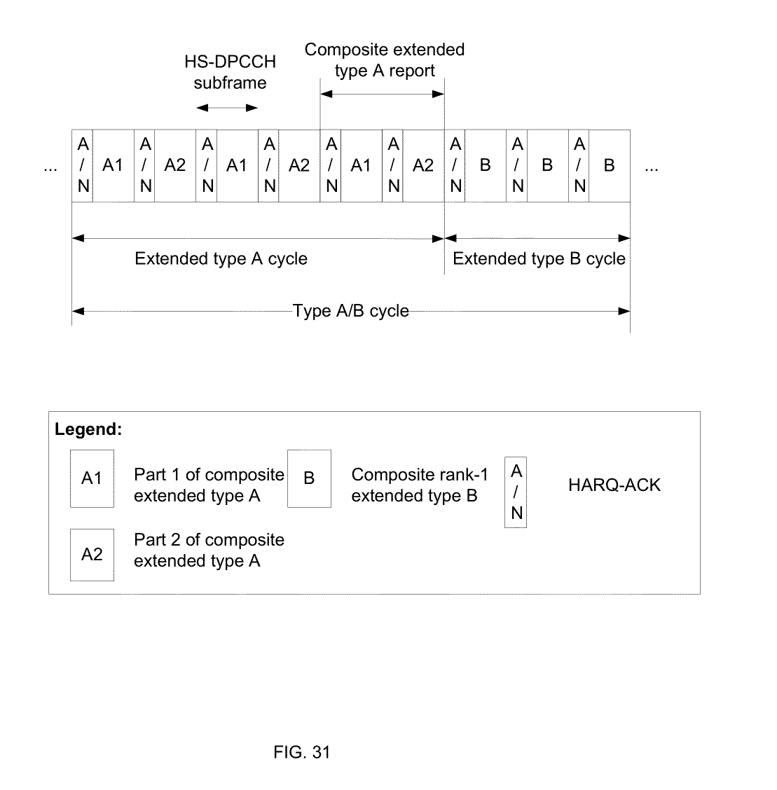

In an embodiment, the WTRU may transmit the rank-1 feedback report and the low-rank feedback report to the Node-B. For example, the WTRU may intersperse the low-rank feedback report and the rank-1 feedback report in a slot reserved for type-B reports. FIG. 31 shows example alternate high-rank/low-rank feedback information reporting. As shown, a CQI cycle may include an extended type A cycle and an extended type B cycle. The extended type A cycle may include multiple composite extended type A reports. For example, and as shown in FIG. 31, an extended type A cycle may include 6 HS-DPCCH subframes, each carrying a part 1 or part 2 of the composite extended type A report. The extended type B cycle may include multiple composite extended type B reports. For example, and as shown in FIG. 31, an extended type B cycle may include 3 HS-DPCCH subframes, each carrying a composite rank-1 extended type B report.

While alternate high-rank/low-rank feedback information reporting is described in the context of composited extended type A and type B reports, it should be understood that alternate high-rank/low-rank feedback information reporting may be applicable to other feedback formats or approaches.

FIG. 20 illustrates example multiplexing and coding for low-rank feedback reporting. For example, the WTRU may transmit a 1 bit RI. The RI may indicate an HS-PDSCH transmission rank preferred by the WTRU and/or whether the feedback is associated with rank-1 or rank-2. The WTRU may transmit the preferred PMI and associated CQI for the preferred rank. As shown, the PMI and the CQI may be multiplexed to form a vector of uncoded multiplexed PMI and CQI bits, Qc. In an embodiment, the PMI may include 4 bits, and the CQI may include 5 bits. A total of 10 bits may be transmitted, for example, using a (20,10) channel code. In an embodiment, the PMI may include 4 bits, and the CQI may include 6 bits and may carry the CQI associated to up to 2 codewords carrying the rank indication implicitly. A total of 10 bits may be transmitted, for example using a (20,10) channel code. This feedback report is referred to as the low-rank composite RI/PMI/CQI report or as the composite low-rank extended type B report herein.

FIG. 21 illustrates example multiplexing and coding for low-rank feedback reporting for two layers. As shown, the CQI reports related to the two layers may be transmitted in a TDM fashion in two consecutive subframes. For example, when the rank indicator indicates rank-2, feedback information may be transmitted in accordance with FIG. 21, and when the rank indicator indicates rank-1, the CQI reports may be in single layer report format.

In an embodiment, the CQI for a codeword may be expressed in reference to the CQI for another codeword. For example, the CQI for the second codeword may be expressed as an offset, or increment value with reference to the CQI index of the first codeword. The second CQI may be calculated by adjusting the first CQI based on the offset. The offset value may include fewer bits than a complete CQI. For example, the CQI for the first codeword may be presented by 5 bits and the offset for the second CQI may include 3 bits.

The RI and the offset CQI may be jointly encoded. The rank indication may be correlated with the offset information. For example, the values of the offset CQI may be divided into different ranges, and a range may implicitly indicate a rank number.

Feedback information may be provided for dual-carrier HSDPA (DC-HSDPA) with 4-branch MIMO enabled. To increase the downlink peak data rate, 4-branch MIMO feature be enabled simultaneously with the DC-HSDPA. The CQI feedback information that may support DC-HSDPA and 4-branch MIMO may include two sets of RI, PMI, and CQIs parameters. Each set may be associated with 4 layers for a carrier. The ACK feedback information may include the acknowledge messages for total of 4 codewords, with 2 of which being associated to each carrier. Though the embodiments are described under the context of dual carrier operation, it is understood that the embodiments may be generalized to simultaneous downlink transmission with more carriers, for example, 4C-HSDPA or 8C-HSDPA.

In an embodiment, CQI coding schemes such as (20,7) and/or (20,10) Reed Miller codes may be used. For each carrier, the CQI and related control information for 4 layers may be mapped to the corresponding HS-DPCCH field of two consecutive subframes. The resulting CQI and HARQ-ACK reports for the two carriers can be multiplexed, for example, using TDM, dual channelization codes, and/or reduced spreading factor schemes( ).

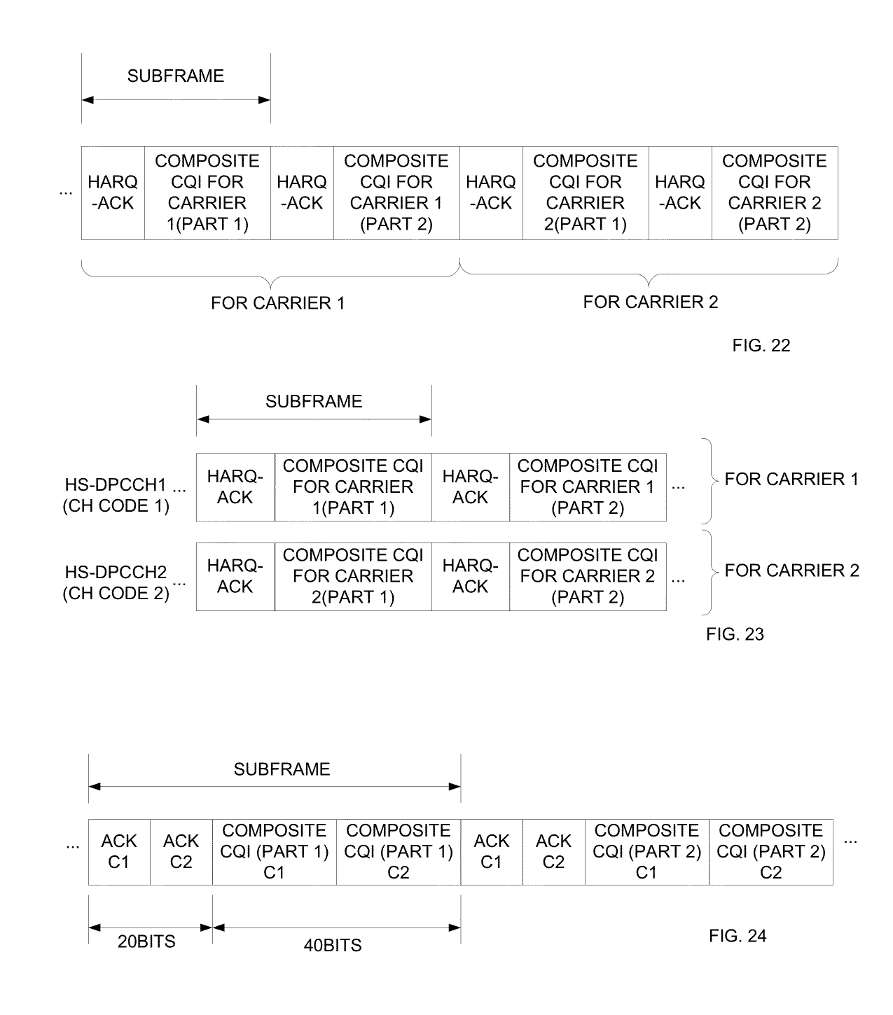

FIG. 22 illustrates example HS-DPCCH subframes carrying feedback information for DC-HSDPA. As shown, the CQI reports may be concatenated in time across 4 subframes. HARQ-ACK information with the TDM-based format can be reported in every subframe by using the codebook for MIMO DC-HSDPA. Joint ACK/NACK states for 4 codewords may be supported. The minimal feedback cycle may include 8 ms.

In an embodiment, multiple HS-DPCCHs with different channelization codes may be used to carry feedback information. For example, two HS-DPCCHs with different channelization codes may be used to carry feedback information for DC-HSDPA. FIG. 23 illustrates example HS-DPCCH subframes carrying feedback information for DC-HSDPA using dual channelization codes. The information field for a carrier may be mapped to one of the HS-DPCCHs. As shown in FIG. 23, a first HS-DPCCH such as HS-DPCCH₁ with channel code 1 may carry feedback information for a first carrier, and a second HS-DPCCH such as HS-DPCCH₂ with channel code 2 may carry feedback information for a second carrier. Each HS-DPCCH may carry HARQ-ACK for the corresponding carrier. The MIMO ACK/NACK codebook may be used.

In an embodiment, the spreading factor of HS-DPCCH may be reduced from 256 to 128. The WTRU may transmit 60 bits in a subframe, which may be sufficient to create two fields for each of the two carriers. FIG. 24 illustrates example HS-DPCCH subframes carrying feedback information for DC-HSDPA where feedback information is multiplexed based on reduced spreading factor. In FIG. 24, “C1” may represent the feedback information for a first carrier, and “C2” may represent the feedback information for a second carrier. It is understood that in addition to the example arrangement order shown in FIG. 24, other forms of field arrangement may be used when using a reduced spreading factor. The information field for a carrier may be mapped to a HS-DPCCH subframe. The MIMO ACK/NACK codebook may be used.

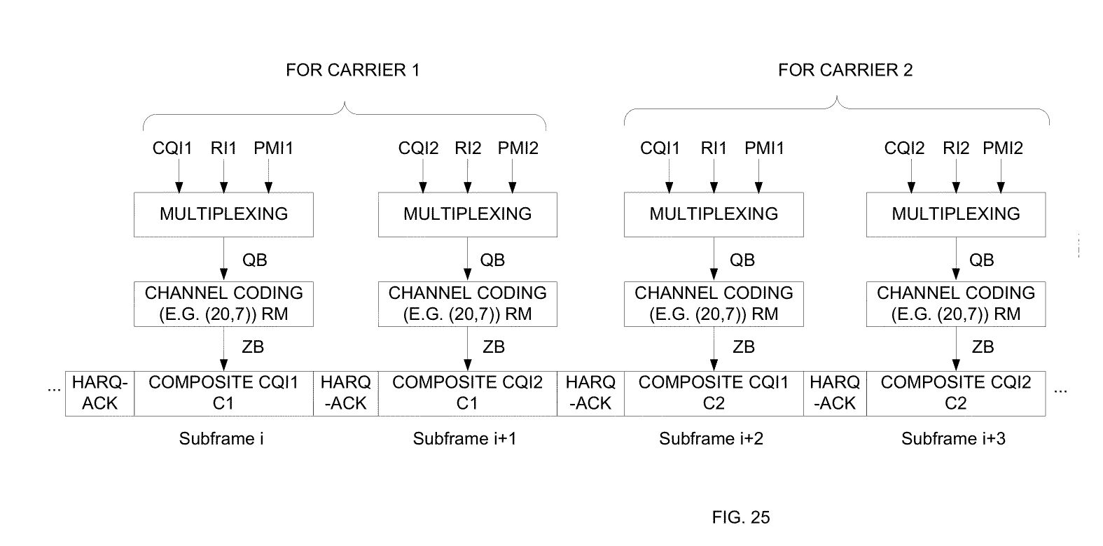

FIG. 25 illustrates example HS-DPCCH subframes carrying feedback information for DC-HSDPA. As shown, feedback information for multiple carriers may be multiplexed based on a TDM approach, where feedback information for the carrier have equal code rates. As shown, the feedback information for a first carrier may be transmitted in two consecutive subframes such as subframe i and subframe i+1, and the feedback information for a second carrier may be transmitted in two consecutive subframes such as subframe i+2 and subframe i+3. The composite CQI reports in the subframes may have the same length.

In an embodiment, the feedback information for a carrier may be mapped to the CQI field of a HS-DPCCH subframe. For example, the feedback information for a carrier may include CQIs for two codewords such as CQI₁ having 4 bits, CQI₂ having 4 bits, RI having 1 bit, and PMI having 4 bits. The range of CQI value may indicate a preferred layer, and the RI field may indicate additional rank preference. A CQI encoding scheme of code rate (20,13) may be used.

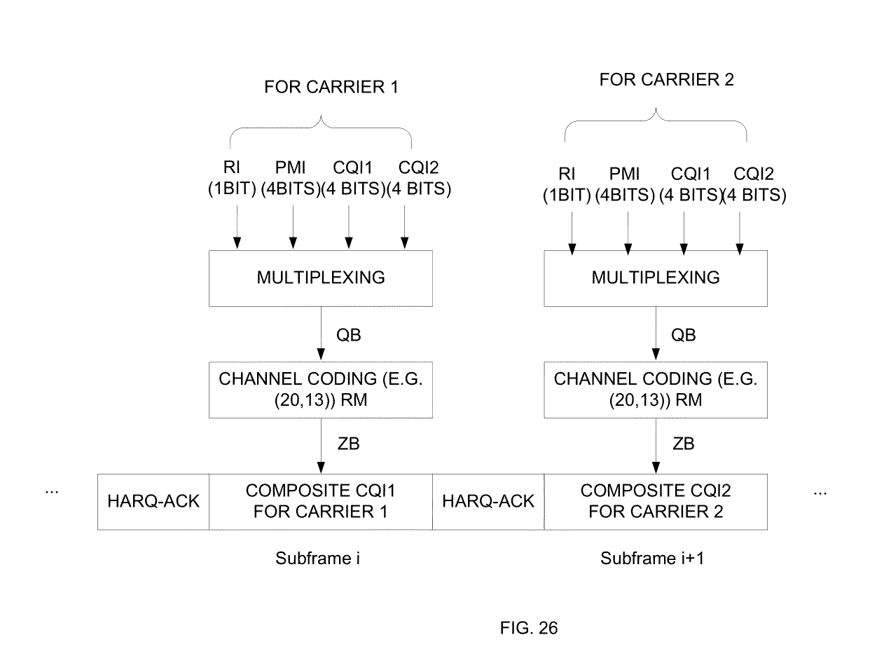

FIG. 26 illustrates example HS-DPCCH subframes carrying feedback information for DC-HSDPA, where the feedback information for a carrier may be mapped to the CQI field of a HS-DPCCH subframe. The feedback information for the two carriers may be multiplexed in a TDM fashion. For example, the feedback information for a first carrier may be carried in a first subframe such as subframe i, and the feedback information for a second carrier may be carried in a second subframe such as subframe i+1. For HARQ-ACK information, the feedback for the codewords of a carrier may be reported on every subframe. The ACK/NACK messages for the carriers may be jointly encoded into a composite state. The HARQ-ACK coding scheme specified for MIMO DC-HSDPA may be used.

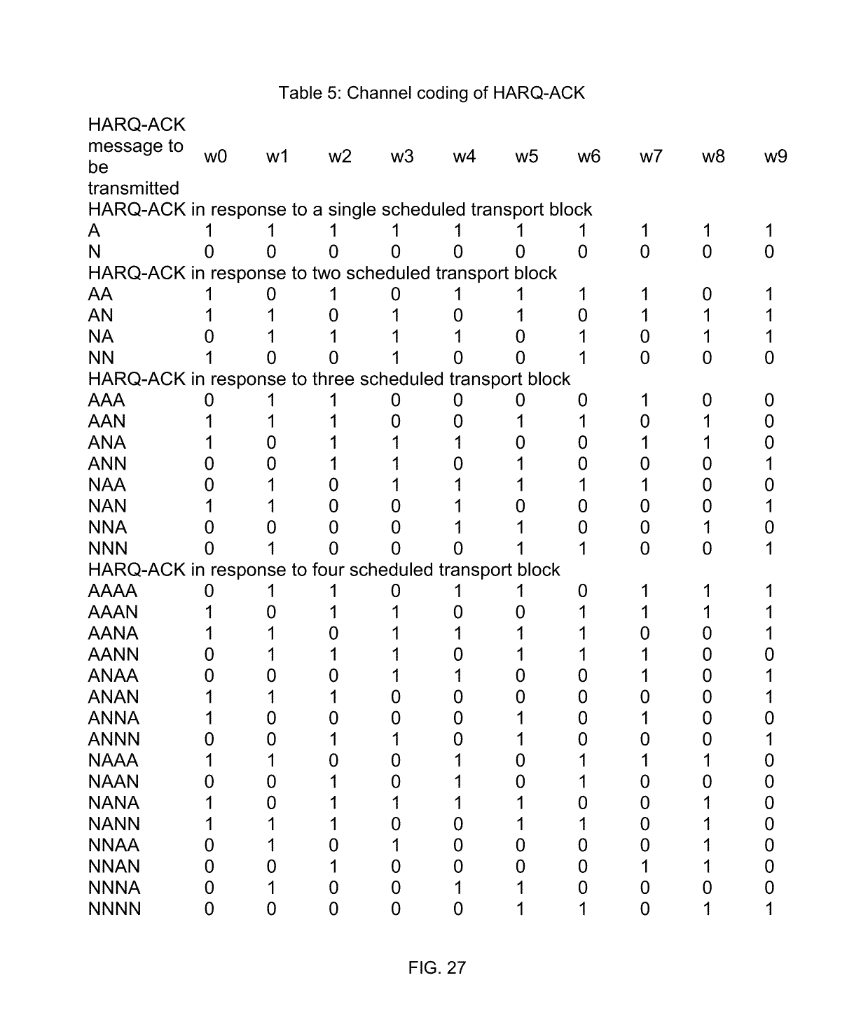

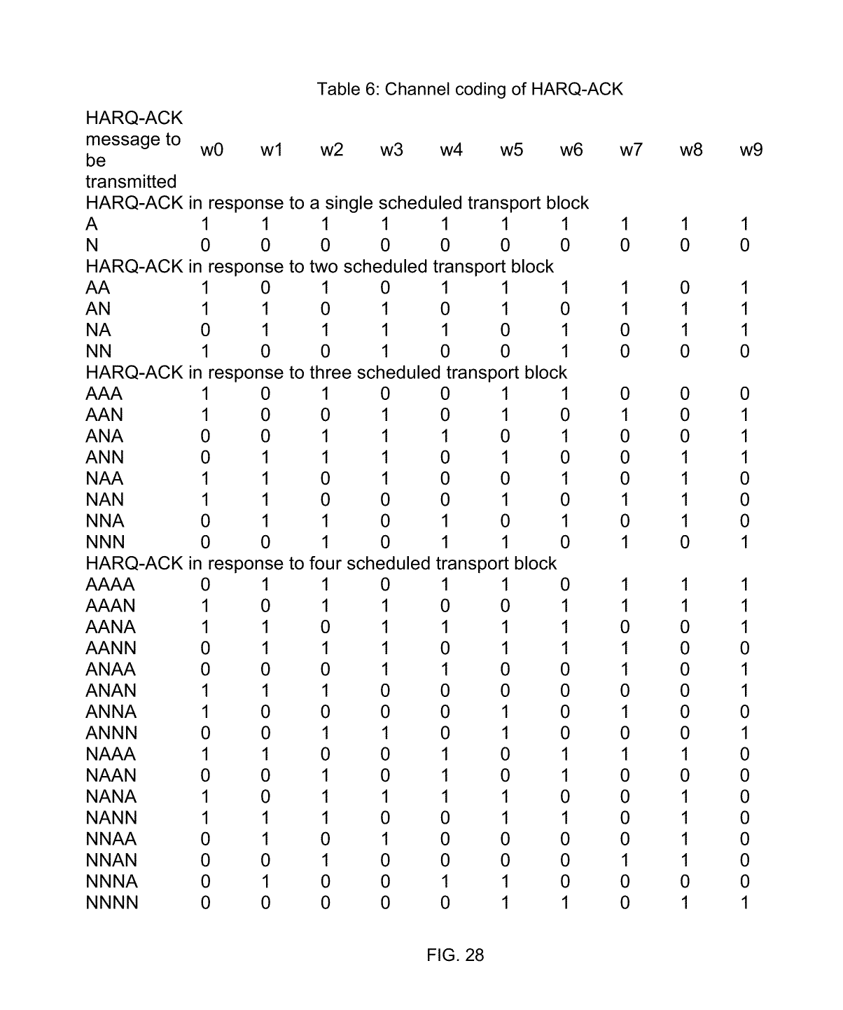

In an embodiment, the maximum number of transport blocks may be 4. An ACK/NACK codebook designed for 4-Tx MIMO may be used. FIGS. 27 and 28 illustrate example channel coding for HARQ-ACK. The HARQ acknowledgement message to be transmitted may be coded to 10 bits, may be denoted as w0, w1, . . . , w9. In FIG. 27, “A” may represent “ACK,” and “N” may represent “NACK.” For single scheduled transport block and two scheduled transport blocks, the codebook may be selected such that the minimum hamming distance may be maximized. The channel coding is compatible with release 7 SC-MIMO codebook. For three scheduled transport block and four scheduled transport block, a portion of DC-MIMO codebook can be used. The codebook may apply to providing feedback for three-cell or four-cell operations.

In an embodiment, a product based on precoding codebook may be used for signaling PMI. Multiple codebooks, such as two codebooks may be used. An overall precoder W can be expressed as W=W⁽¹⁾W⁽²⁾, where W⁽¹⁾ may reflect the long-term channel properties and W⁽²⁾ may represent the short-term channel properties. W⁽¹⁾ and W⁽²⁾ may be referred to herein as long-term channel component and short-term channel component, respectively. In the context of dual-codebook approaches, W⁽¹⁾ may change at a slower rate than W⁽²⁾. An update rate for W⁽¹⁾ may be lower than an update rate for W⁽²⁾.

Long-term channel component may be transmitted over E-DPDCH. The WTRU may, in view of transmitting the long-term channel component at a lower rate, signal the long-term channel component W⁽¹⁾ over the E-DPDCH, while signaling the short-term channel component W⁽²⁾ using the HS-DPCCH. Signaling the long-term channel component W⁽¹⁾ over the E-DPDCH may obviate a need for a new or modified feedback channel.

Since the channel information is destined to the serving Node-B, the information may be included at the MAC-level to enable the Node-B to decode. The long-term channel component (LTCC) W⁽¹⁾ or an indication of the W⁽¹⁾ may be transmitted in one or more modes.

In a first mode, or standalone mode, the WTRU may transmit the long-term channel component information. The WTRU may transmit the long-term channel component on a separate E-DPDCH transmission. The long-term channel component may be carried in, for example, a special MAC header to notify the Node-B of a presence of the information. The WTRU may use part of a non-scheduled grant for transmission. The WTRU may assume that it can transmit the long-term channel component information regardless of the grant. The WTRU may be configured to use a HARQ profile for a “control only” E-DCH transmission to transmit the standalone long-term channel component information.

In a second mode, the long-term channel component information may be transmitted along with uplink data. The WTRU may transmit the long-term channel component with the data transmission. The long-term channel component may be carried, for example, in a MAC header field (LTCC).

In a third mode, the long-term component information may be transmitted along with scheduling information. The WTRU may transmit the LTCC as a field in the SI. For example, the size of the SI field may be increased, and/or an entry may be added to the E-TFC TBS tables.

In an embodiment, long-term codebook information may be transmitted over data channel E-DPDCH using one or more mechanism for improving transmission reliability.

In an example mechanism, codebook information may be sent un-scheduled. The codebook information may be transmitted regardless of the serving grant. When the long-term codebook information is present, the UL-MIMO capable WTRU may force rank 1 transmission on E-DPDCH, even when a higher rank transmission may be possible. In an example mechanism, the long-term codebook information may be transmitted over the strongest eigen-channel when UL MIMO transmission with rank greater than one is allowed. The strongest eigen-channel may be determined based on a primary precoding weight vector. Both mechanisms may be applicable when scheduling information needs to be transmitted.

In the first and third modes described above, an E-DPDCH-to-DPCCH power offset to be used may be configured by RRC signaling. The transmission may be repeated until an ACK is received from the serving cell or the maximum number of transmission attempts is reached.

In the second and third modes described above, the long-term channel component and/or scheduling information may be transmitted using the same hybrid ARQ profile as the highest-priority MAC-d flow in the transmission. The WTRU may be configured with and may use a higher maximum number of HARQ transmissions for LTCC transmission. The codebook information and/or scheduling information may be transmitted using a HARQ process, including the processes that are deactivated for data transmission.

The WTRU may be configured to transmit the long-term channel component periodically or when triggered. For example, the WTRU may be configured to transmit the LTCC at regular time interval. The network may indicate the time interval to the WTRU. If, for example, the WTRU has no data to transmit when periodic LTCC transmission is due, the WTRU may transmits the LTCC using the first and/or the third modes described above. The WTRU may transmit an SI along the LTCC.

The WTRU may transmit the LTCC when the LTCC value changes significantly. For example, the LTCC may be transmitted when a change in value exceeds a predetermined threshold. For example, the WTRU may determine that the previously transmitted LTCC may not represent the overall precoder, and may transmit a new LTCC.

The WTRU may transmit the LTCC upon receiving a request. For example, the network may signal a request for LTCC the WTRU to transmit the LTCC. The request for LTCC may be carried in a HS-SCCH order on the E-AGCH and/or in a MAC-level message on the HS-DSCH.

The WTRU may signal the long-term channel component W⁽¹⁾ over the HS-DPCCH at a slower update rate, while signaling the short-term channel component (STCC) using the HS-DPCCH.

The WTRU may be configured with a set of parameters defining the periodic pattern for transmission of the LTCC. The WTRU may be configured with a parameter N_LTCC that may indicate to the WTRU to transmit the LTCC based on time-alternation. For example, the parameter N_LTCC may indicate to the WTRU to transmit the LTCC in every n HS-DPCCH subframes, or every n transmissions of the STCC, where n may be a value included in or indicated by the N_LTCC parameter. When transmitting the LTCC, the WTRU may transmit the LTCC in place of the STCC, or in place of the regular PCI/CQI.

The WTRU may explicitly indicate on the HS-DPCCH the nature of the channel component it carries. For example, a bit on the HS-DPCCH may indicate whether the associated channel component index is the long-term channel component or the short-term channel component.

The WTRU may report a precoding index to a specific value in a codebook. Such a precoding index may be referred to as a precoding matrix indication (PMI). A value in the codebook may carry the weight information for one or more layers.

A codebook for the PMI may be selected based on the rank. The PMI index may point to a value in a codebook associated to a specific HS-PDSCH transmission rank. The WTRU may determine the HS-PDSCH transmission rank and the precoding matrix index to report. The determination may be based on the appropriate codebook.

The WTRU may configured with a single codebook, where an entry in the codebook may be associated to a specific rank, e.g., based on the number of columns in the matrix. When a maximum of 2 codewords may be transmitted simultaneously, with each codeword carried on up to 2 physical layers, the WTRU may indicate which layers reported may be associated together to carry a single codeword.

In an embodiment, the WTRU may associate a layer in a PMI with a specific codeword based on one or more preconfigured rules. In an example, the association may be implicit based on the total number of layers indicated for example by the PMI. The association may be based on the number of preferred codewords as indicated by the CQI.

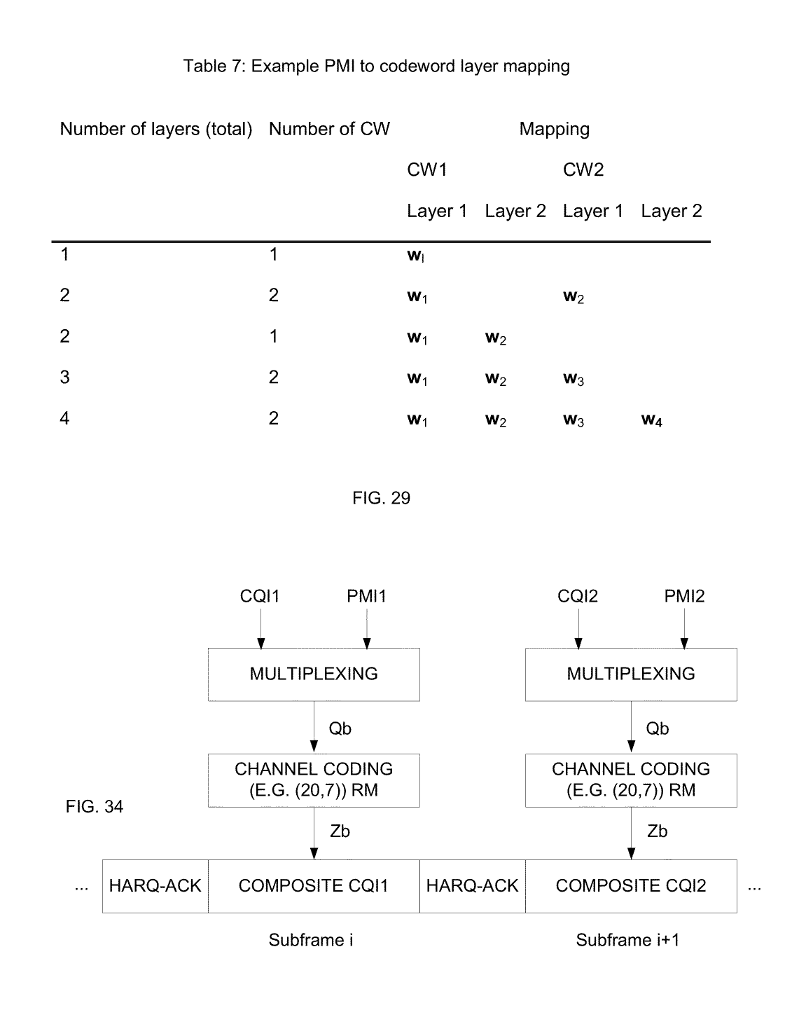

FIG. 29 illustrates example PMI to codeword layer mapping. In FIG. 29, the 1th column or vector associated to the PMI index may be denoted as w1, where 1=1, 2, . . . 4 (or up to the number of layers that may be used) indicates the layer index. As shown, the layer reported by the PMI may be mapped to the associated channel quality as reported by the associated CQI for up to two codewords. It is understood that while FIG. 29 illustrates an example mapping for up to 4 layers and 2 codewords, other mapping may also be provided.

In an embodiment, multiple CQI tables may be used in reporting the feedback information. The WTRU may select a CQI table from the multiple CQI tables based on the reported rank of the associated CQI. In the context of 4-branch MIMO for HSDPA, a codeword may contain up to two transport blocks, and a CQI may be reported per codeword.

For example, when configured for 4-branch MIMO operations for HSDPA, the WTRU may be configured with two sets of CQI tables. A first table, such as CQI rank-1 table (also referred to as “CQI table R1” herein) may include rank-1 CQI reporting information. A second table, such as CQI rank-2 table (also referred to as “CQI table R2” herein) may include rank-1 CQI reporting information. The WTRU may be configured with other CQI tables that may include CQI reporting information related to other ranks, such as rank-3, rank-4, etc.

The CQI tables may be of the same size. The tables may be indexed using 5 bits, and may include up to 32 entries. The CQI table R2 may support larger data rates than CQI table R1. In an embodiment, the CQI tables may have overlapping entries. This may provide additional scheduling flexibility.

The Node-B may be configured with the multiple CQI tables such that the Node-B may interpret the received feedback information. For example, the Node-B may receive a feedback report from the WTRU. Based on the rank indication in the feedback report, the Node-B may determine which CQI table to use. The Node-B may look up channel quality information on the determined CQI table based on the received CQI.

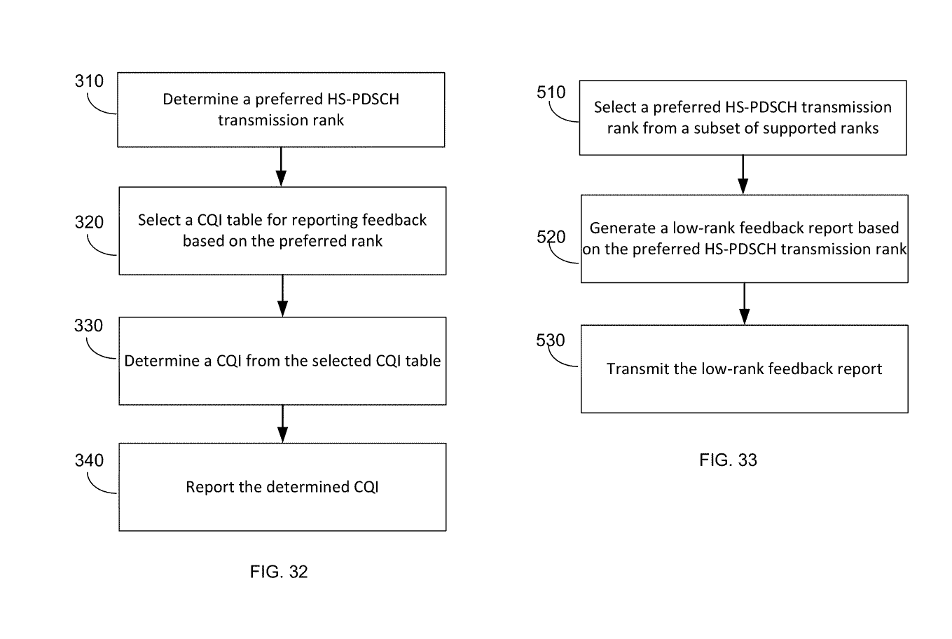

FIG. 32 illustrates example process for reporting feedback using multiple CQI tables. At 310, the WTRU may determine a preferred rank associated with DL operations. For example, the WTRU may determine a preferred rank, such as rank-1 or rank-2, for a reported codeword. At 320, the WTRU may select a CQI table for reporting feedback from multiple configured CQI tables based on the preferred rank. For example, the WTRU may use CQI table R1 upon a determination that the WTRU may prefer a rank-1 transmission for the associated codeword, and may use CQI table R2 upon a determination that the WTRU may prefer a rank-2 transmission for the associated codeword. At 330, the WTRU may determine the CQI from the selected CQI table. At 340, the WTRU may report the determined CQI to the network along with a rank indication.

In an embodiment, aperiodic channel state information (CSI) reports may be transmitted. For example, a CSI report may be transmitted upon receiving a trigger for CSI reporting. The trigger may be explicit or implicit. For example, a base station may signal a trigger for aperiodic CSI report to the WTRU.

The WTRU may transmit CSI reports when receiving one or more explicit triggers. Example explicit triggers may include, but not limited to, a request for an aperiodic CSI report in an HS-SCCH order, an indication of change of reporting mode or state in an HS-SCCH order, an indication of change of reporting mode or state in an HS-SCCH order associated with an HS-PDSCH, and/or a request from the Node-B via L2 or a physical channel signaling.

In an embodiment, the WTRU may be configured with a secondary E-DCH radio network temporary identity (H-RNTI) that may be separate from the primary H-RNTI. The WTRU may monitor the HS-SCCH for the H-RNTI and the secondary H-RNTI. The WTRU may apply the HS-SCCH order, or a subset of the order when received using the secondary H-RNTI. The HS-SCCH order format may be different when received using the primary H-RNTI than when received using the secondary H-RNTI. The WTRU may apply the order the same way regardless of the H-RNTI was used to carry it. In an embodiment, the secondary H-RNTI may be shared among a group of WTRUs. This may help reducing control channel overhead.

The WTRU may transmit CSI reports based on one or more implicit triggers for aperiodic CSI reporting and changes in channel state information reporting. Example implicit triggers may include, but not limited to, receiving an HS-SCCH order indicating that the number of layers of the associated HS-PDSCH is above/below a configured number of layers (threshold), receiving an HS-SCCH indicating that the number of transport blocks carried the associated HS-PDSCH is above/below a configured number of transport blocks (threshold), receiving an uplink grant above a configured threshold, failing to decode more or less than a configured number of transport blocks (e.g., on the first transmission, or after a pre-configured maximum number of retransmission) in a given configured time period, successfully decoding more or less than a configured number of transport blocks (e.g., on the first transmission, or after a pre-configured maximum number of retransmission) in a given configured time period, an estimation that the average BLER is above/below a configured threshold (the averaging period and parameters may be pre-configured), an estimation that the average BLER after the first transmission may be above/below a configured threshold (the averaging period and parameters may be pre-configured), an estimation that the average number of retransmissions for a given configured time period may be larger than a configured threshold, a determination that the channel has changed significantly since the last report has been transmitted, a determination that the CQI value has changed by more than a configured threshold since the last report has been transmitted, a determination that the number of layers has changed by more than a configured threshold since the last report has been transmitted, and/or a determination that the PCI/PMI has changed by more than a configured amount since the last report has been transmitted.

The triggers may be combined with a counter or timer with predefined or configured parameters. For example, the WTRU may count the number, N_{count}, of HS-SCCH indicating an HS-PDSCH with a configured number of layers in a given pre-defined or configured period, Tₜᵢₘₑᵣ. The period may be defined in units of subframes. The WTRU may compare the count with a configured threshold, Nₜₕᵣₑₛₕ. Based on the comparison, the WTRU may determine whether to activate the action(s) associated to the trigger.

Upon detecting a trigger for aperiodic CSI reporting, the WTRU may perform one or more actions. For example, the WTRU may report an extended or a partial CSI on the HS-DPCCH, even if the transmission may fall outside the periodic transmission cycle. The WTRU may report an extended or a partial CSI on a L2 message or in a message header (e.g. in a MAC-ehs header). The WTRU may indicate the cause of the aperiodic report. The WTRU may change the channel information reporting period upon detecting a trigger. For instance, the WTRU may be configured with different channel information reporting periods and may change from one reporting period to another reporting based on the triggers. For example, the WTRU may be configured with a first channel information reporting period of 8 ms or 4 TTIs and a second channel information reporting period of 4 ms or 2 TTIs.

In an embodiment, the WTRU may calculate the values associated with an aperiodic CSI report when being triggered to do so.

For 4-branch MIMO for HSDPA, a complete CSI report may include feedback for the layers and TBs being transmitted. For example, when the WTRU supports rank 4 transmission, a complete CSI report may include the CQI/PMI for the layers/TB conditioned on rank 4, 3, 2 and 1 transmission. When the WTRU supports rank-3 transmission, a complete CSI may include the CQI/PMI for the layers/TB conditioned on rank 3, 2 and 1 transmission. The completed CSI report may also be referred to as the “extended CSI report” herein. For example, when the WTRU detects an explicit HS-SCCH order requesting for feedback, the WTRU may transmit a complete CSI report using a L2 message.

In an embodiment, periodic or aperiodic CSI report may include a partial CSI report. For example, a partial CSI report may include a preferred rank, PMI and CQI for each layer/TB. For example, a partial CSI report may include a preferred rank, PMI and CQI for a particular layer/TB.

In the context of 4-layer MIMO operations, a partial CSI report may include PMI and CQI for a subset of the layers/TBs. For example, the partial CSI report may include PMI and CQI conditioned on the HS-PDSCH transmission rank. In a given reporting period, the HS-PDSCH transmission rank may include the WTRU's preferred rank or a fixed rank. The partial CSI report may be transmitted during periodic CSI report to reduce the overhead. An extended CSI report may include more information than the partial CSI report. For example, an extended CSI report may include the CQI and PMI for all layer/TB for the supported ranks.

In an embodiment, the WTRU may change a downlink reception mode along with the reporting mode. For instance, when the WTRU changes the reporting feedback to a lower rate, the WTRU may reconfigure for dual-stream or single-stream reception on the HS-PDSCH. When the WTRU changes the reporting feedback to a high rate, the WTRU may be reconfigured for multi-stream, such as more than 2 streams, reception.

In an embodiment, the WTRU may change the channel state information feedback cycle upon detecting an explicit HS-SCCH order requesting such a change in reporting mode. The WTRU changes a configuration on the maximum number of layers or transport blocks that the WTRU may receive in a TTI. This approach may allow the Node-B to control the amount of feedback control based on the channel condition and expected downlink traffic for a given WTRU.

In an embodiment, a method for feeding back to a base station (“BS”) from a wireless-transmit-and-receiving unit (“WTRU”) information associated with a downlink channel supporting a plurality of multiple-input-multiple-output (“MIMO”) streams (“feedback information”) may be provided. The method may include, encoding first and second portions of the feedback information so as to form first and second encoded portions, respectively, and transmitting, from the WTRU to the BS, the first encoded portion separately from the second encoded portion. The feedback information may include channel state information (“CSI”) associated with at least one transport block transmitted via at least one MIMO stream. The first portion may include precoding control information (“PCI”) and/or rank information (“RI”) associated with the at least one transport block, and the second portion may include channel quality information (“CQI”) associated with the at least one transport block.

The first encoded portion may be transmitted separately from the second encoded portion. For example, the first encoded portion may be transmitted in a first subframe of a radio frame adapted for transmission on an uplink channel from between the WTRU and the BS, and the second encoded portion may be transmitted in a second subframe of the radio frame. For example, the first encoded portion may be transmitted separately from the second encoded portion using a minimum amount of transmissions from the WTRU to the BS.

The feedback information may include CSI for at least one transport block (“TB”) transmitted via at least one MIMO stream, and a combination of the first and second subframes may define a minimum reporting period for CSI for the at least one TB. For example, the CSI may define PCI, RI and/or CQI for the at least one TB. The first portion may include the PCI and/or RI, and the second portion may include the CQI.

The first and second portions of the feedback information may be encoded by encoding each of the first and second portions using a code for coding an uplink channel from between the WTRU and the BS. The code may include a block code for encoding a CQI, precoding control PCI and RI associated with a transport block transmitted via a plurality of MIMO streams. The block code may be formatted as a type A code or a type B code.

The uplink channel may include a channel in accordance with a protocol for a high-speed dedicated physical control channel (“HS-DPCCH”) of a high speed data packet access (“HSDPA”) scheme.

The second portion may include first CQI) associated with a first transport block transmitted via at least one first MIMO stream, and second CQI associated with a second transport block transmitted via at least one second MIMO stream. The first and second encoded portions of the feedback information may be encoded by multiplexing the first CQI and the second CQI so as to form a multiplexed second portion, and encoding the multiplexed second so as to form the second encoded portion. The first and second encoded portions may be encoded by encoding the first portion using a code so as to form the first encoded portion having a first code rate, and encoding the second portion using the code so as to form the second encoded portion having a second code rate. The first encoded portion may be transmitted at a first power offset, and the second encoded portion may be transmitted at a second power offset.

The WTRU may receive a message may include a request to configure the WTRU to use the first and second power offsets for transmitting the first and second encoded portions, respectively, and configuring the WTRU to use the first and second power offsets for transmitting the first and second encoded portions, respectively.

The first and second portions of the feedback information may be encoded by encoding the first portion with a first code, and encoding the second portion with a second code.

The first portion may include PCI and RI associated with at least one transport block transmitted via at least one MIMO stream. The first and second portions of the feedback information may be encoded by multiplexing the PCI and the RI so as to form a multiplexed first portion, and encoding the multiplexed first portion so as to form the first encoded portion. The PCI may be defined as a set of bits (“PCI bits”), the RI may be defined as a set of bits (“RI bits”) and the PCI and the RI may be multiplexed by joining the PCI bits and the RI bits so as to form a composite set of bits having a subordinate set of bits. The multiplexed first portion may be encoded to form the first encoded portion by encoding the composite set of bits with a code providing a greater level of protection against error to the subordinate set of bits than other bits of the composite set of bits. The composite set of bits may include a most significant bit (“MSB”), and the subordinate set of bits may include the MSB. The composite set of bits may include a lease significant bit (“LSB”), and the subordinate set of bits may include the LSB. The subordinate set of bits may include at least one of the PCI bits. The subordinate set of bits may include at least one of the RI bits.

In an embodiment, the feedback information may include channel state CSI for at least one TB transmitted via at least one MIMO stream, and the CSI may define rank RI and CQI for the at least one TB. The first portion may include a representation of the RI, and the second portion may include the CQI. The RI may be recoverable from a combination of the representation of the RI and the CQI. The CSI may include precoding control information, and the first portion may include the precoding control information.

In an embodiment, the at least one TB may include a single TB transmitted via a single MIMO stream. The CQI may include a single CQI associated with the single TB. The representation of the RI may be indicative of the single MIMO stream. The combination of the representation of the RI and the CQI may be indicative of a single TB transmitted via a single MIMO stream.

In an embodiment, the at least one TB may include a single TB transmitted via a plurality of MIMO streams. The CQI may include a single CQI associated with the single TB. The representation of the RI may be indicative of the plurality of MIMO streams. The combination of the representation of the RI, and the CQI may be indicative of a single TB transmitted via a plurality of MIMO streams.

In an embodiment, the at least one TB may include first and second TBs transmitted via respective single MIMO streams. The CQI may include first and second CQIs associated with the first and second TBs, respectively. The representation of the RI may be indicative of a plurality of MIMO streams responsive to the first and second TBs being transmitted via the first and second single MIMO streams. The combination of the representation of the RI and the CQI may be indicative of a plurality of TBs transmitted via a plurality of MIMO streams.

In an embodiment, the at least one TB may include a first TB transmitted via a single MIMO stream, and a second TB transmitted via a plurality of MIMO streams. The CQI may include first and second CQIs associated with the first and second TBs, respectively. The representation of the RI may be indicative of at least three MIMO streams responsive to the first and second TBs being transmitted via the single and the plurality of MIMO streams, respectively. The combination of the representation of the RI and the CQI may be indicative of a plurality of TBs transmitted via at least three MIMO streams.

In an embodiment, the at least one TB may include first and second TBs transmitted via respective pluralities of MIMO streams. The CQI may include first and second CQIs associated with the first and second TBs, respectively. The representation of the RI may be indicative of at least four MIMO streams responsive to the first and second TBs being transmitted via the respective pluralities of MIMO streams. The combination of the representation of the RI and the CQI may be indicative of a plurality of TBs transmitted via at least four MIMO streams.

The RI may be defined as a set of bits. The representation of the RI may be defined as a subordinate set of the RI bits.

The feedback information may include CSI for at least one TB transmitted via at least one MIMO stream. The CSI may define RI and CQI for the at least one TB. The second portion may include CQI with a representation of the RI embedded therein. The RI may be recoverable from the CQI with a representation of the RI embedded therein. The feedback information may include CSI for at least one TB transmitted via at least one MIMO stream. The CSI may define any of CQI for the at least one TB and other information. The second portion may include the CQI with the other information embedded therein. The other information may be recoverable from the CQI encoded with the other information embedded therein.

The feedback information may include CSI for a plurality of TBs transmitted via a plurality of MIMO streams. The CSI may define for the plurality of TBs, PCI, RI and a respective plurality of CQI. The first and second encoded portions of the feedback information may be encoded by multiplexing the PCI, RI and the plurality of CQIs so as to form multiplexed information, encoding the multiplexed information so as to form encoded-multiplexed information, demultiplexing the encoded-multiplexed information into first and second parts, and mapping the first and second parts to the first and second encoded portions, respectively. The multiplexed information may be encoded so as to form encoded-multiplexed information, by encoding the multiplexed information using a convolution encoder so as to form convolution-encoded-multiplexed information, and puncturing the convolution-encoded-multiplexed information so as to form the encoded-multiplexed information.

The feedback information may include CSI for at least one TB transmitted via at least one MIMO stream. The CSI may define precoding control information for the at least one TB. The precoding control information may include a first component reflecting long-term channel properties and a second component reflecting short-term channel properties. The first portion may include the first and second components.

In an embodiment, the CSI may define precoding control information for the at least one TB. The precoding control information may include a first component reflecting long-term channel properties and a second component reflecting short-term channel properties. For example, the first portion may include the first component or the second component. For example, the first portion may include the second component, and the second portion may include the first component. For example, the second portion may include the first component and the second component.

An example method for feeding back to a base station from a wireless-transmit-and-receiving unit (“WTRU”) information associated with a downlink channel supporting a plurality of multiple-input-multiple-output (“MIMO”) streams may be provided. The method may include encoding first and second portions of the feedback information so as to form first and second encoded portions, respectively, wherein the feedback information may include channel state information (“CSI”) for at least one transport block (“TB”) transmitted via at least one MIMO stream, the CSI may define precoding control information for the at least one TB, the precoding control information may include a first component reflecting long-term channel properties and a second component reflecting short-term channel properties, and the first portion may include the second component. The method may include transmitting, from the WTRU to the BS, the first encoded portion separately from the second encoded portion, encoding the first component so as to form a third encoded portion, and transmitting the third encoded portion from the WTRU to the BS.

The first encoded portion may be transmitted separately from the second encoded portion, by transmitting the first encoded portion separately from the second encoded portion on an uplink control channel from between the WTRU and the BS, and transmitting the third encoded portion comprises: transmitting the third encoded portion on an uplink data channel from between the WTRU and the BS.

An example method for feeding back to a base station (“BS”), from a wireless-transmit-and-receiving unit (“WTRU”), information associated with a downlink channel supporting a plurality of multiple-input-multiple-output (“MIMO”) streams (“feedback information”) may be provided. The method may include encoding a first portion of the feedback information using a first code, encoding a second portion of the feedback information using a second code, and transmitting the first and second portions from the WTRU to the BS.

An apparatus may include a WTRU configured with an extended CQI table having additional entries including at least one of the following fields: the rank information for a specific CQI; the number of HS-PDSCH for the second layer; the modulation for the second layer; the reference power adjustment for the second layer; and, the joint reference power adjustment (for both layers simultaneously). The WTRU may be configured with overlapping transport blocks sizes or transport block sizes ranges. The WTRU may report the highest CQI it can support and/or a combination of the highest CQI and modulation/number of layer or rank scheme via the CQI index value. The WTRU may be configured with an SNR penalty to apply when calculating CQI for rank-2 transmission. The WTRU may be configured to report the CQI value requiring the least amount of receive energy, or equivalently the most efficient CQI value. In an embodiment, the extended CQI table may not contain overlapping TBS values. A codebook for PMI that may be selected based on the rank may be used. The PMI index may point to a value in a codebook associated to a specific HS-PDSCH transmission rank.

An apparatus may be configured to utilize a single large codebook, and wherein each entry in the codebook is associated to a specific rank (e.g. based on the number of columns in the matrix).

An example method for reporting feedback from a WTRU over two or more HS-DPCCH subframes may be provided. The WTRU may transmit the feedback information (RI, PMI, CQI) for its preferred rank. The WTRU may transmit CQI for up to two codewords. One codeword may include up to two TBs. The WTRU may transmit CQI for each codeword using 4 bits (e.g. as in Type A CQI), or using 5 bits such as type B CQI reporting. The feedback may include RI: 2 bits, PMI: 4 bits, CQI1: 5 bits, and/or CQI2: 5 bits, where CQI1 may be the CQI for the first codeword and CQI2 may be the CQI for the second codeword. RI and CQI1 may be jointly coded and transmitted in a first HS-DPCCH subframe, and the PMI and CQI2 may be jointly coded and transmitted in a subsequent HS-DPCCH subframe. RI and PMI may be jointly coded and transmitted first followed by the CQI1 and CQI2 in a subsequent subframe.

An example method for transmitting composite CQI reports having different field lengths may be provided. The composite CQI reports may have different code rates when encoded to the 20 bit field into a subframe. Different power offsets may be applied to the corresponding HS-DPCCH fields respectively. The entry to a pre-defined power table may be moved up one or more steps with reference to that of the RI/CQI report.

An example method for transmitting composite CQI reports having the same field lengths wherein RI and PMI fields are both split into two parts may be provided. The RI fields may include RI1=r₀, which may be a preferred number of layers for codeword #0, and RI2=r₁, which may be a preferred number of layers for codeword #1. The PMI fields may include PMI1=pmi₀pmi₁ and PMI2=pmi₂ pmi₃. In an embodiment, the existing (20,7) Reed Muller in the 3GPP standard may be used, and the bit fields of the two subframes may be arranged as follows (without restricting the order):

ith subframe is mainly for codeword #0: cgi_{0,0}cqi_{0,1}cqi_{0,2}cqi_{0,3}r₀pmi₀pmi₁

(i+1)th subframe is mainly for codeword #1: qi_{1,0}cqi_{1,1}cqi_{1,2}cqi_{1,3}r₁pmi₂pmi₃,

where cqi_{1,k} is the k^{th} bit for the CQI associated to codeword #1.

An example method for transmitting low-rank feedback reports for a 4-branch MIMO channel may be provided. A WTRU may transmit a low-rank feedback at regular intervals, with the multiplexing and channel coding for the HS-DPCCH. A PMI field may include 4 bits. The low-rank feedback report may include a rank-1 composite PMI/CQI report. The low-rank feedback report may be a low-rank composite RI/PMI/CQI report. When the rank indicator indicates rank=2, CQI reports related to the two best layers may be transmitted in a TDM fashion in two consecutive subframes. CQI for the second codeword may be expressed as an offset, or increment value with reference to the CQI index of the first codeword. The RI and the offset CQI may be jointly encoded. The values of the offset CQI may be divided into different ranges, and wherein each may implicitly may indicate a certain rank number.

An example method for feedback information up to two codewords for dual-carrier HSDPA (DC-HSDPA) may be provided. The CQI feedback information to support the joint operation may include two sets of RI, PMI, and CQIs parameters with each set being capable of support 4 layers for a carrier. ACK feedback information may include acknowledge messages for total of 4 codewords, with 2 of which being associated to each carrier.

An example method of feedback reporting may be provided. The method may include, for each carrier, mapping CQI and related control information for 4 layers to a corresponding HS-DPCCH field of two consecutive subframes, and multiplexing the corresponding CQI and HARQ-ACK reports for the two carriers using one of TDM, dual channelization codes; or reduced spreading factor.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system described above are possible without departing from the scope of the invention. In view of the wide variety of embodiments that can be applied, it should be understood that the illustrated embodiments are exemplary only, and should not be taken as limiting the scope of the following claims. For instance, in the exemplary embodiments described herein include handheld devices, which may include or be utilized with any appropriate voltage source, such as a battery and the like, providing any appropriate voltage.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the exemplary embodiments are not limited to the above-mentioned platforms or CPUs and that other platforms and CPUs may support the described methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It should be understood that the exemplary embodiments are not limited to the above-mentioned memories and that other platforms and memories may support the described methods.

What is claimed:

1. A wireless transmit/receive unit (WTRU) that supports receiving information via a plurality of multiple-input-multiple-output (MIMO) streams, the WTRU comprising:
a processor configured to:
select a preferred HS-PDSCH transmission rank from a subset of a plurality of ranks that the WTRU supports, wherein the subset comprises ranks that are lower than a maximum rank supported by the WTRU, and
generate a low-rank feedback report based on the preferred High Speed-Physical Downlink Shared Channel (HS-PDSCH) transmission rank; and
a transceiver configured to transmit the low-rank feedback report.

2. The WTRU of claim 1, wherein the low-rank feedback report comprises a rank indicator indicating the preferred HS-PDSCH transmission rank.

3. The WTRU of claim 1, wherein the low-rank feedback report comprises precoding control information (PCI), and the processor is further configured to determine a PCI based on the preferred HS-PDSCH transmission rank.

4. The WTRU of claim 1, wherein the low-rank feedback report comprises channel quality information (CQI), and the processor is further configured to determine a CQI based on the preferred HS-PDSCH transmission rank.

5. The WTRU of claim 1, wherein the low-rank feedback report comprises channel quality information (CQI) associated with a second best stream when the preferred HS-PDSCH transmission rank is rank-2.

6. The WTRU of claim 1, wherein the WTRU is further configured to:
generate a rank-1 feedback report comprising a PCI associated with a best stream and a CQI associated with the best stream; and
provide the low-rank feedback report and the rank-1 feedback report to a base station interspersedly.

7. The WTRU of claim 6, wherein the WTRU is further configured to:
generating a type A feedback report comprising a CQI associated with a first codeword and a CQI associated with a second codeword, and
the transceiver is further configured to:
transmit the CQI associated with the first codeword and the CQI associated with the second codeword in separate high speed dedicated physical control channel (HS-DPCCH) subframes, and
transmit the low-rank feedback report and the rank-1 feedback report in separate HS-DPCCH subframes.

8. The WTRU of claim 1, wherein the WTRU is further configured to:
determine a preferred rank associated with downlink operations;
select a CQI table based on the preferred rank; and
determine a CQI from the selected CQI table.

9. The WTRU of claim 8, wherein the transceiver is further configured to transmit the CQI along with an indication of the preferred rank.

10. A method for supporting a plurality of multiple-input-multiple-output (MIMO) streams in a downlink, the method comprising:
selecting a preferred HS-PDSCH transmission rank from a subset of a plurality of ranks that a WTRU supports, wherein the subset comprises ranks that are lower than a maximum HS-PDSCH transmission rank supported by the WTRU, and
generating a low-rank feedback report based on the preferred HS-PDSCH transmission rank; and
transmitting the low-rank feedback report.

11. The method of claim 10, wherein the low-rank feedback report comprises a rank indicator indicating the preferred HS-PDSCH transmission rank.

12. The method of claim 10, further comprising:
determining low-rank feedback report comprises precoding control information (PCI) based on the preferred HS-PDSCH transmission rank; and
determining low-rank feedback report comprises channel quality information (CQI) based on the preferred HS-PDSCH transmission rank, wherein the low-rank feedback report comprises the PCI and the CQI.

13. The method of claim 10, wherein the low-rank feedback report comprises channel quality information (CQI) associated with a best stream and channel quality information (CQI) associated with a second best stream when the preferred HS-PDSCH transmission rank is rank-2.

14. The method of claim 10, further comprising:
generating a type A feedback report comprising feedback information associated with the maximum HS-PDSCH transmission rank supported by the WTRU;
generating a rank-1 feedback report comprising feedback information associated with a best stream; and
interspersing the type A feedback report, the low-rank feedback report and the rank-1 feedback report when sending feedback information to a base station.

15. The method of claim 14, wherein the type A feedback report comprises a CQI associated with a first codeword and a CQI associated with a second codeword, and the method further comprises:
transmitting the CQI associated with the first codeword and the CQI associated with the second codeword in separate high speed dedicated physical control channel (HS-DPCCH) subframes; and
transmitting the low-rank feedback report and the rank-1 feedback report in separate HS-DPCCH subframes.

16. The method of claim 10, further comprising:
determining a preferred rank associated with downlink operations;
selecting a CQI table based on the preferred rank; and
using the selected CQI table when providing feedback information to a base station.

17. A wireless transmit/receive unit (WTRU) that supports receiving information via a plurality of multiple-input-multiple-output (MIMO) streams, the WTRU comprising:
a processor configured to:
generate a first channel quality information (CQI) report associated with a first codeword for transmission in a first MIMO stream, a second CQI report associated with a second codeword for transmission in a second MIMO stream and a precoding control information (PCI);
split the PCI into a first portion and a second portion;
multiplex and jointly encode the first CQI report and the first portion of the PCI for transmission in a first High Speed Dedicated Physical Control Channel (HS-DPCCH) subframe; and
multiplex and jointly encode the second CQI report and the second portion of the PCI for transmission in a second HS-DPCCH subframe.

18. The WTRU of claim 17, wherein the first and the second portion of the PCI are of the same size.

19. The WTRU of claim 17, wherein the processor is further configured to:
embed a rank indicator (RI) indicating a preferred rank HS-PDSCH transmission rank associated with the first codeword into the first CQI report.

20. The WTRU of claim 17, wherein the processor is further configured to:
generate a rank indicator (RI) indicating a preferred rank HS-PDSCH transmission rank associated with the first codeword; and
multiplex and jointly encode the RI with the first CQI report and the first portion of the PCI for transmission in the first HS-DPCCH subframe.
